(19) United States
(12) Patent Application Publication
(10) Pub. No.: US 2016/0196076 A1
(43) Pub. Date: Jul. 7, 2016

(54) MEMORY SYSTEM AND METHOD FOR CONTROLLING SAME

(71) Applicant: WILUS INSTITUTE OF STANDARDS AND TECHNOLOGY INC., Seoul (KR)

(72) Inventor: Hyunoh OH, Gwacheon-si, Gyeonggi-do (KR)

(73) Assignee: WILUS INSTITUTE OF STANDARDS AND TECHNOLOGY INC., Seoul (KR)

(21) Appl. No.: 14/903,599

(22) PCT Filed: Jul. 8, 2014
(86) PCT No.: PCT/KR2014/006095

§ 371 Date: Jan. 8, 2016

Related U.S. Application Data
(60) Provisional application No. 61/843,898, filed on Jul. 8, 2013.

(51) Int. Cl. G06F 3/06; G06F 12/10

(52) U.S. Cl. CPC G06F 3/0616; G06F 12/1009; G06F 3/0644; G06F 3/0658; G06F 3/0679; G06F 2212/1036; G06F 2212/2022; G06F 2212/652

(57) ABSTRACT

The present invention relates to a memory system and a method for controlling the same, and more particularly, to a memory system for efficiently processing data and a method for controlling the same.

To this end, provided are a method for controlling a memory system, including: dividing, respectively, at least one page in the memory into a plurality of subpages, the page being an aggregate of memory cells corresponding to the same logical address in the memory and the respective subpages having a predetermined size; writing, in response to a writing request of data, the data in a first subpage in the page; and writing the data in a second subpage of the page in response to an update request for the data, the update request being a rewriting request after an initial writing request for the corresponding data and a memory system using the same.

### TECHNICAL FIELD

The present invention relates to a memory system and a method for controlling the same, and more particularly, to a memory system for efficiently processing data and a method for controlling the same.

### BACKGROUND ART

A memory device is the most requisite microelectronic element in a digital logic design. The memory device is largely divided into a volatile memory device and a non-volatile memory device. Although a power of the non-volatile memory device is cut off, the non-volatile memory device can store data. The data stored in the non-volatile memory can be permanent or reprogrammed according to a memory manufacturing technique. The non-volatile memory device can be used in applications of various industrial fields.

As a representative example of the non-volatile memory device, a flash memory is provided. The flash memory can be used in numerous media storing data, such as a smart phone, a digital camera, a solid-state drive (SSD), and a black box. In particular, since the SSD using a NAND flash memory has small power consumption, can be miniaturized, and is resistant to an impact as compared with a hard disk drive (HDD), the SSD can be widely used even as primary storage media such as a laptop, a desktop, and a server. Furthermore, in recent years, there is a trend that with the development of the smart phone and the SSD, availability of the NAND flash memory has gradually increased.

Basically, a cell of the flash memory can write and erase data by filling and emptying electrons in and from a floating gate. In more detail, when voltage enough to cause a tunnel effect is applied to a control gate in a state of an empty cell, some of electrons which move from a source to a drain pass through an oxide film which is an insulator due to an influence of an electric field generated according to the applied voltage to fill the electrons of the floating gate. Next, when the applied voltage is cut off, the electrons filled in the floating gate covered with the insulator are confined in the floating gate. Therefore, the electrons can be kept while the electrons are filled in the floating gate even though power is not supplied. A write operation of the flash memory cell can be implemented by the aforementioned operations.

When positive voltage which may cause a tunnel release is applied to a P layer while the electrons are filled in the floating gate, the electrons confined in the floating gate can be discharged to the outside of the floating gate through an insulating layer. As a result, the cell may return to an empty state again. An erase operation of the flash memory cell can be implemented by the aforementioned operations.

However, the NAND flash memory has a disadvantage in that overwrite in-place of data is not permitted unlike a DRAM or the HDD. That is, for overwriting, a part previously written in the memory cell is erased and thereafter, overwriting needs to be performed. In other words, before data is written in the flash memory, the data needs to return to an initial state or an erased state. This is referred to as an erase-before-write operation. Therefore, a problem occurs, in which the entire block is first erased and thereafter, all pages in the corresponding block need to be rewritten even when changing data of 1 byte due to a characteristic of a cell of which overwriting is impossible (herein, the minimum wise of writing and reading of the NAND flash memory is the page and the minimum wise of erase is the block).

Since a state change of the memory cell described above causes abrasion of the memory cell, only a predetermined number of times of overwriting can be generally permitted in the cell of the flash memory. That is, when the predetermined number of times of overwriting is exceeded, additional overwriting is not permitted any more and only reading is just possible. Therefore, since the service life of the flash memory cell is not permanent, an additional technique for prolonging the service life of the flash memory cell is required to be used for storing data.

A wear leveling technique is provided as a representative technique among techniques for prolonging the service life of the flash memory. Since data (hot data) which are frequently updated and data (cold data) which are not frequently updated can be generated due to a characteristic of a data access pattern, a cell in which abrasion occurs comparatively more and a cell in which the abrasion occurs less can be provided. Accordingly, a core of the wear leveling technique is to arrange data by evenly distributing erasing and overwriting operations of data in the memory cell in order to prevent the service life of a specific cell from first expiring due to concentration of abrasion on the specific cell.

In more detail, the SSD (alternatively, the NAND flash memory) can write and manage the number of times the overwriting operation is performed for every page included in the SSD through a page register, and the like. Therefore, a controller (for example, a flash translation layer (FTL)) of the SSD performs and changes appropriate mapping between a logical address and a physical address by referring to the number of overwriting times when receiving a writing request to control a page which is yet less used (that is, of which the number of overwriting times is small) among empty pages to be primarily written. Therefore, the wear leveling technique can permit the block-wise erasing operation to be minimized and all pages of the NAND flash memory to be evenly used. The wear leveling technique is generally performed together with a copy back page operation and a garbage collection operation to prolong the service life of the NAND flash memory.

The wear leveling technique of the related art can be commonly called a macro wear leveling technique. The macro wear leveling technique represents a scheme that implements the erasing and overwriting operations to be evenly distributed by the wise of the page as described above. Since the page-wise (alternatively, block-wise) wear leveling technique has a limit in increasing the service life of the NAND flash memory, an additional technique for further increasing the service life of the NAND flash memory is required in the art.

There is a trend that a storage capacity of the flash memory has gradually increased. Moreover, a block size and a page size in the flash memory have also increased for efficient addressing. However, since a large majority of files of which the amount used is large are small-sized files even up to now, the page may be inefficiently used in the situation in which only one file can be stored in one page.

### DISCLOSURE

### Technical Problem

The present invention has been made in an effort to efficiently use a memory system.

### Technical Solution

An exemplary embodiment of the present invention provides a method for controlling a memory system including a memory and a memory controller configured to control the memory, including: determining a current in-page write mode based on the number of data resetting times in one page constituting the memory; allocating in-page bit positions to respective data bits to be written in the one page based on the determined current in-page write mode; and writing the data bits to be written in the one page.

The allocating may include allocating the in-page bit positions to the respective data bits to be written in the one page by performing a shifting operation to an in-page bit position allocated according to a previous in-page write mode based on the determined in-page write mode by at least one bit position.

The allocating may include allocating an in-page bit position to respective data bits to be written in one page by performing a scrambling operation at an in-page bit position allocated according to the previous in-page write mode based on the determined current in-page write mode.

In this case, each of the plurality of respective pages may additionally include spare bits.

The allocating may include allocating the in-page bit position to the respective data bits to be written in one page by placing, in a reverse order, the in-page bit position allocated according to the previous in-page write mode based on the determined current in-page write mode.

The writing may include inverting values of respective data bits depending on the previous in-page write mode based on the determined current in-page write mode; and writing the respective data bits having the inverted values in one page.

The method may further include determining a type of data to be written; and determining a wear leveling technique for writing the respective data bits in the page based on the determined data type.

In this case, the number of data resetting times may be determined based on an erase (erase_count) value, a wear_count, or a write_count value.

The method may further include determining at least one of a type (Data_type) of data to be written, a file size (Data_size) including the data to be written, and read counts (Read_count) for the plurality of respective pages; and selecting one ECC among a plurality of error correction codes (ECCs) having different levels based on the decision.

Another exemplary embodiment of the present invention provides a memory system including a memory including a plurality of physical blocks, each of the plurality of physical blocks including a plurality of pages; and a memory controller configured to determine a current in-page write mode based on the number of data resetting times in one page constituting the memory device and allocate in-page bit positions to respective data bits to be written in the one page based on the determined current in-page write mode; and a programming module configured to include writing the data bits to be written in the one page according to the allocated in-page bit positions.

Yet another exemplary embodiment of the present invention provides a method for controlling a memory system including a memory and a memory controller configured to control the memory, including: dividing at least one page in the memory into a plurality of respective subpages, the page being an aggregate of memory cells corresponding to the same logical address in the memory and the respective subpages having a predetermined size; writing, in response to a writing request of data, the data in a first subpage in the page; and writing the data in a second subpage of the page in response to an update request for the data, the update request being a rewriting request after an initial writing request for the corresponding data.

The writing of the data in the first subpage may include determining the size of data of which writing is requested; determining whether the determined size of the data is smaller than the size of the subpage; and writing the data in the divided first subpage when the determined data size is smaller than the size of the subpage.

The method may further include: setting a write mode count based on the number of writing request times for the data; and sequentially writing the data in the divided subpages according to the set write mode count.

The method may further include: reading a value of the written data, wherein a subpage to be read among the plurality of subpages is determined based on the value of the set write mode count.

The subpages at least may include a plurality of states including a valid state in which a final update value of the data is written, an obsolete state in which a value before the update request of the data is written, and an empty state in which the data is yet not written, and a state of the first subpage may be changed from the valid state to the obsolete state to correspond to the writing the data in the second subpage.

The method may further include reading the value of the written data, wherein a value of data written in a last subpage which is positioned previous to a subpage having an initial empty state in writing order of the data in the plurality of subpages may be read.

Still another exemplary embodiment of the present invention provides a memory system, including: a memory having a plurality of physical blocks, each of the plurality of physical blocks including a plurality of pages; and a memory controller configured to control the memory, wherein the memory controller includes a control module dividing, respectively, at least one page in the memory into a plurality of subpages, the page being an aggregate of memory cells corresponding to the same logical address in the memory and the respective subpages having a predetermined size; and a programming module writing the data in a first subpage in the page in response to a writing request of data and writing the data in a second subpage of the page in response to an update request for the data, the update request being a rewriting request after an initial writing request for the corresponding data.

### Advantageous Effects

According to exemplary embodiments of the present invention, micro wear leveling can be efficiently implemented in a memory system.

A data file having a smaller size than a page which can be a basic wise of a logical/physical address of a memory can be efficiently processed.

### DESCRIPTION OF DRAWINGS

FIG. 1 illustrates a probabilistic distribution of binary 1 in each bit position in a byte.

FIG. 2 is a diagram schematically illustrating a memory system 200 according to an aspect of the present invention.

FIG. 3 is a diagram schematically illustrating a memory system 300 according to an aspect of the present invention.

FIG. 4 is a diagram illustrating a method for implementing in-page bit level wear leveling according to an exemplary embodiment of the present invention by using a shifting operation.

FIG. 5 illustrates a data structure for one page in which micro wear leveling is performed according to an aspect of the present invention.

FIG. 6 is a diagram illustrating a method for implementing in-page bit level wear leveling according to an exemplary embodiment of the present invention by using a reversing operation.

FIG. 7 is a diagram illustrating a method for implementing in-page bit level wear leveling according to an exemplary embodiment of the present invention by using an inversing operation.

FIG. 8 illustrates a probabilistic distribution of binary 1 for each bit position between micro wear leveling techniques using rotation, reversing, and inversing operations according to an aspect of the present invention and the wear leveling technique according to the related art.

FIG. 9 illustrates a method for performing wear leveling according to an aspect of the present invention.

FIG. 10 illustrates an exemplary memory system for implementing data writing subordinated to a data type according to an aspect of the present invention.

FIG. 11 illustrates an exemplary memory system for reading data written dependently on a data type according to an aspect of the present invention.

FIG. 12 exemplarily illustrates a file subordinated transformation process using mapping information between a file type and a transform type stored in a look-up table according to an aspect of the present invention.

FIG. 13 illustrates a data writing method through the file subordinated transformation system according to an aspect of the present invention.

FIG. 14 illustrates a data allocation algorithm considering an ECC type according to an aspect of the present invention.

FIG. 15 illustrates a data format related with a count operation in the existing SSD and a data format according to an aspect of the present invention.

FIGS. 16 and 17 illustrate data formats for storing count values according to an aspect of the present invention.

FIG. 18 illustrates a bit error for the data format according to an aspect of the present invention.

FIG. 19 illustrates a data format in which bit error correction is easy according to an aspect of the present invention.

FIG. 20 illustrates a data format in which bit error correction is easy according to another aspect of the present invention.

FIG. 21 exemplifies a statistic distribution of a file-size wise.

FIG. 22 illustrates an in-page overwriting method according to an aspect of the present invention.

FIG. 23 illustrates an additional description of the in-page overwriting method according to an aspect of the present invention.

FIG. 24 is a flowchart for an in-page data writing method according to an aspect of the present invention.

### BEST MODE

Various aspects are now described with reference to the drawings and like reference numerals are generally used to designate like elements. In the following exemplary embodiments, for description, multiple specific detailed matters are presented to provide general understanding of one or more aspects. However, it will be apparent that the aspects can be implemented without the detailed matters.

Various aspects of the disclosed contents will be described below. The descriptions in the present specification may be implemented in broad forms. Further, it is apparent that a predetermined specific structure, functionality, or both of them disclosed herein are just representative. Based on the description in the present specification, those skilled in the art should be recognize that the aspect disclosed herein can be implemented independently from other predetermined aspects and two or more aspects among the aspects can be combined by various methods. For example, an apparatus can be implemented or a method can be executed by using aspects of a predetermined number presented herein. Further, the apparatus can be implemented or the method can be executed by using other structures, functionalities, or structures other than or in addition to those of one or more aspects among the aspects presented herein. Moreover, an aspect of the present invention may include at least one element of claims.

The present specification exemplarily discloses a flash memory, but other memory device (for example, volatile memory) other than the flash memory (that is, non-volatile memory) may also be included in the scope of the preset invention.

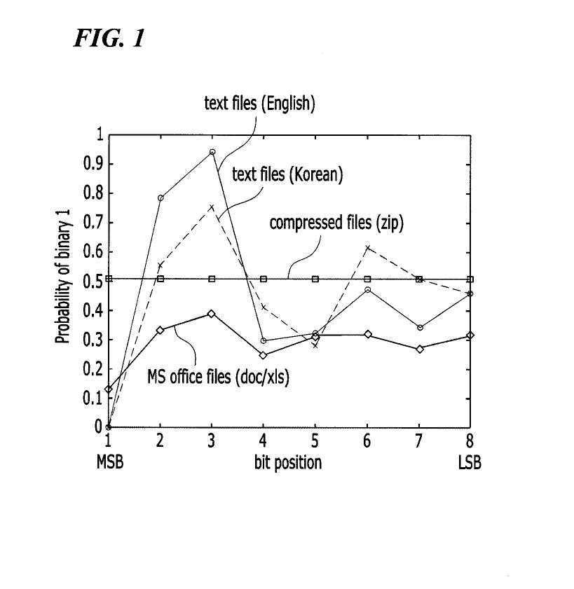

FIG. 1 illustrates a probabilistic distribution of binary 1 in each bit position in a byte. Referring to FIG. 1, probabilistic bit position distributions of data for various types of files are presented. The data types illustrated in FIG. 1 are just examples and various other data types may also be included in the scope of the present invention.

As illustrated in FIG. 1, except for a compressed file, bit distributions biased in the byte may be present according to the file type. For example, a most significant bit (MSB or bit position 1) of “text file_English” may dominantly hold binary 0 and bit positions 2 and 3 may dominantly hold binary 1. In more detail, when the text files (for example, files in which the MSB is mapped to 0 and bit positions 2 and 3 are mapped to 1) are repeatedly overwritten, the MSB of the memory will be abraded more rapidly than bit positions 2 and 3.

Due to a physical characteristic of a flash memory, a memory cell after an erase operation has a value of binary 1. In such a state, a state of the memory cell needs to be changed to 0 in order to store binary 0 during a data write operation, but the state of the memory cell may not be changed in order to store binary 0. Moreover, in order to overwrite the corresponding memory cell, the erase operation is first performed due to a physical characteristic of the flash memory, and as a result, the state of the memory cell needs to be set to 1. Accordingly, storing data 1 or erasing data stored as 1 may less consume durability of the cell than storing data 0. In other words, in order to maximize the service life of the flash memory such as an SSD, or the like, it should be considered to implement even distribution of binary 1's and 0's in the bit-wise.

However, since in the macro wear leveling technique of the related art, wear leveling is performed in the page (alternatively, block)-wise, a micro wear leveling technique which may control data distribution in a block or page (for example, the byte-wise or bit-wise) is not considered at all.

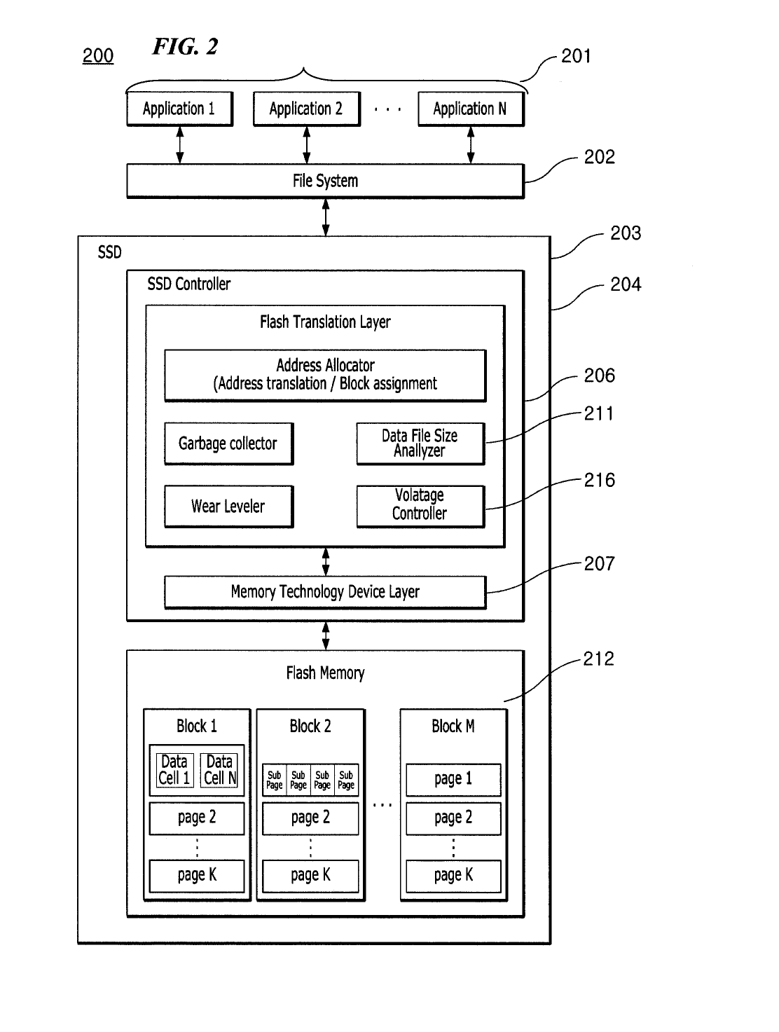

FIG. 2 is a diagram schematically illustrating a memory system 200 according to an aspect of the present invention.

In FIG. 2, the memory system 200 may be largely constituted by an application 201 (alternatively, host), a file system 202, and an SSD 203. Components in FIG. 2 are just examples and some of the components in FIG. 2 may be omitted or components other than the components in FIG. 2 may be included in the memory system 200. Additionally, the SSD 203 in FIG. 2 may be substituted with a memory and a memory controller capable of performing similar functions.

In an aspect of the present invention, applications 1 to N 201 may include a predetermined device or program requiring data storage to the flash memory device such as the SSD.

In an aspect of the present invention, the file system 202 may be designated as the host or an application area together with the application 201. The file system 202 may access predetermined data of the SSD through a logical sector address. In this case, a flash translation layer 206 translates the logical sector address into a physical address to map the logical sector address onto the physical address. Additionally, the file system 202 may represent a virtual sector implemented by the flash translation layer 206. Further, the file system 202 in the present specification may be used to be exchanged with the application 201.

Due to a physical characteristic of the flash memory 205, separate management of read, write, erase and operations is required to use the flash memory 205 like a hard disk. The flash translation layer 206 may represent system software developed for such a purpose. The flash translation layer 206 includes a mapping algorithm translating the logical address into the physical address and a wear leveling algorithm for performing wear leveling.

In an aspect of the present invention, the flash translation layer 206 may include an address allocator 208 for mapping the logical address and the physical address, a wear leveler 210 for performing the wear leveling, a garbage collector 209, a data file size analyzer 211 for analyzing and comparing the size of a data file, and a voltage controller 216 for controlling voltage to be applied to the flash memory 205. Additionally, the components of the flash translation layer 206 are just examples and additionally components may be included in the flash translation layer 206 or some of the components may be omitted.

The address allocator 208 may implement allocation of the logical address and the physical address in the block-wise, page-wise, or bit (cell)-wise of the memory. Therefore, data inserted into an appropriate physical block location, page location, and/or bit position may be allocated in order to implement the wear leveling. Additionally, the address allocator 208 may create a mapping table for mapping bits inserted into memory cells (for example, MLC, TLC, and the like) having a plurality of voltage state levels, and the like to appropriate voltage state levels.

The wear leveler 210 may perform the wear leveling in the block-wise, page-wise, and/or bit-wise. Description regarding the bit-wise wear leveling (that is, in-page wear leveling) will be made below.

The garbage collector 209 performs an operation of marking unnecessary data (invalid data or obsolete data), a copy back operation to another block, page, and/or bit, and an operation of erasing the unnecessary data at once to implement the wear leveling.

The voltage controller 216 may, for example, apply to the memory cell a driving voltage level having a value equal to or higher than a previous in-cell write mode in order to express one or more bits. The applying of the voltage may be performed based on the mapping table created by the address allocator 208. Further, the voltage controller 216 checks a voltage level of the memory cell corresponding to one or more bits written in the previous memory cell to determine a driving voltage level value to be applied to the memory cell. Herein, the in-cell write mode may indicate a value to count the number of in-cell write times in one erase cycle (alternatively, erase count).

The data file size analyzer 211 may determine the size of the inserted data file. Through the determination, the data file size analyzer 211 may, for example, determine whether the inserted data file has a smaller size than divided subpages.

Although not illustrated in FIG. 2, the flash translation layer 206 of the SSD controller 204 may include a hot data identifier. The hot data identifier performs an operation of identifying and detecting data (hot data) which are frequently accessed and data (cold data) which are not frequently accessed to assist the implementation of the wear leveling.

Although not illustrated in FIG. 2, the SSD controller 204 may include a programming unit (write and erase) and a reading unit for writing, erasing, and reading data with respect to the flash memory 205.

The SSD controller 204 may control all operations of the SSD. The SSD controller 204 may receive the logical address from the application 201 or the file system 202. The flash translation layer 206 of the SSD controller 204 may translate the received logical address into the physical address. The translated physical address may be transferred to a memory technology device layer 207 or the flash memory 205. The memory technology device layer 207 may represent an interface layer for supporting various flash memories or RAMs. Additionally, the memory technology device layer 207 may be an optional component.

The flash memory 205 may be constituted by a plurality of memory cells having a string structure as well known to those skilled in the art. An aggregate of the memory cells is generally designated as a cell array. The cell array of the flash memory 205 is constituted by a plurality of memory blocks. Each of the memory blocks 212 is constituted by a plurality of pages 213. Each page is constituted by a plurality of memory cells or data cells 214 sharing one word line. Herein, single bit data, multiple bit data, or triple bit data may be stored in one memory cell or data cell 214. The memory cell in which the single bit data may be stored is designated as a single level cell (SLC), a memory cell in which the multi bit data may be stored is designated as a multi level cell (MLC), and a memory cell in which the triple bit data may be stored is designated as a triple level cell (TLC).

In an aspect of the present invention, each page 213 in the block 212 in the flash memory 205 may be constituted by a plurality of subpages 215. For example, when the size of the page 213 is 4 KB, four subpages 215 per 1 KB may be formed in one page 213.

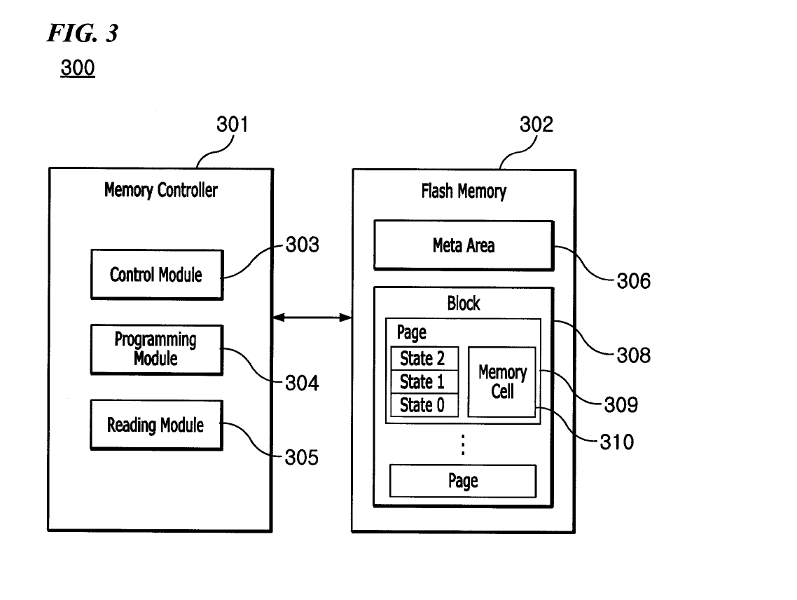

FIG. 3 is a diagram schematically illustrating a memory system 300 according to an aspect of the present invention.

As illustrated in FIG. 3, the memory system 300 may include a memory controller 301 and a flash memory 302.

The memory controller 301 may control all operations of the flash memory 302. The memory controller 301 may include a control module 303 for performing wear leveling, bit allocation, voltage control, and page division, a programming module 304 for performing the write and erase operations, and a reading module 305 for performing the read operation.

In an aspect of the present invention, the control module 303 may perform the wear leveling, the bit allocation, the voltage control, and the page division based on meta data stored in a meta area 306, and the like when receiving an operation request for the flash memory 302 from the host or application. Further, the control module 303 may control operations of the programming module 304 and the reading module 305.

In an aspect of the present invention, the control module 303 may determine an in-cell write mode based on the number of data write request times for the memory cell. The control module 303 may determine a driving voltage level value to be applied in order to express one or more bits in the memory cell based on the determined in-cell write mode. Further, the control module 303 may create a mapping table in which one or more bits are mapped to a high or equivalent level state from low state levels among state levels of the memory cell according to the in-cell write mode. The created mapping table may be stored in the flash memory 302 (for example, the meta area 306).

The control module 303 may select, based on a plurality of predetermined factors, one of a technique of writing one or more information wises in the memory cell one time in one erase cycle by using states of the same number as the maximum number of states which may be expressed in the memory cell and a technique of writing one or more information wises in one erase cyclein the memory cell multiple times by using states of the number smaller than the maximum number of the states which may be expressed in the memory cell. The selection may be determined based on factors such as an attribute of data, the size of the data file, a wear leveling state in the flash memory, and the like.

The control module 303 may divide a page 310 of the flash memory 302 into subpages. Further, the control module 303 may sequentially allocate divided inserted data (overwritten data) to the divided subpages. Herein, the sequentially allocated data may correspond to the same logical address. In more detail, the sequentially allocated data may represent the same file.

The allocation may be performed based on the size of data of which writing is requested. Additionally, the control module 303 may set and store state values of the respective subpages. The state values may include a valid state which is a state to possess a value of data, an obsolete state which is a state which is not required due to data overwriting to another subpage, and an empty state which is a state in which data is not yet written.

Wear leveling according to an additional aspect of the present invention may represent not inter-page wear leveling but in-page wear leveling or micro wear leveling. In more detail, there are many cases in which bad blocks are generally generated when not a group of cells in the page wise but one or more cells are more than an abrasion threshold. Therefore, in order to implement the cell wise (that is, bit level) wear leveling, the control module 303 may determine a current in-page write mode based on the number of data reset times (for example, an erase count value (erase_count) or a wear count value (wear_count)) in one page.

The in-page write mode (for example, w-mode) may represent a value which is referred to perform a change (for example, shift (alternatively, rotating, reversing, and/or scrambling)) of a bit position in the page or a change (for example, inversion) of a data value written in the bit position in the page. For example, in a case of shifting the bit position, the in-page write mode may represent a rotation number for shifting 8-bit positions in 1 byte.

The control module 303 may control the programming module 304 that allows respective data bits to be written in one page to be written in the page according to the current in-page write mode which is determined. In more detail, the control module 303 may allocate an in-page bit position to the respective data bits to be written in one page based on the current in-page write mode which is determined. The allocation may represent allocating the in-page bit position to the respective data bits to be written in one page by performing a shifting operation at the allocated in-page bit position by at least 1 bit position according to the previous in-page write mode. Alternatively, the allocation may represent allocating the in-page bit position to the respective data bits to be written in one page by performing a scrambling operation at the allocated in-page bit position according to the previous in-page write mode. Alternatively, the allocation may represent allocating the in-page bit position to the respective data bits to be written in one page by performing a reversing operation at the allocated in-page bit position according to the previous in-page write mode.

Therefore, the programming module 304 may write the data bits to be written in one page according to the in-page bit position allocated to each data bit to be written.

Additionally, the control module 303 may inverse values of respective data bits according to the previous in-page write mode based on the current in-page write mode which is determined. Accordingly, respective data having the inverted values may be written in one page by the programming module 304.

As described above, since the control module 303 maps the logical address onto the physical address in the byte (alternatively, bit) wise in the page, the micro level wear leveling may be implemented. Accordingly, since distribution of 1 and 0 in a bit plane may be evenly implemented, the service life of the flash memory may be improved.

Additionally, the control module 303 in the present specification associates the bit-wise wear leveling and general page-wise wear leveling and/or block-wise wear leveling to maximize the service life of the flash memory.

Additionally, the control module 303 may determine a type of data to be written and determine a technique for writing respective data bits in one page based on the determined data type. In more detail, the control module 303 may determine the type (for example, file type (doc, xis, ppt, txt, pdf, way, mp3, jpg, zip, and avi)) of the data to be written. Information regarding the file type may be included in the writing request of the data, and the like. When the type of the data to be written is determined, the control module 303 may select an appropriate technique among the micro wear leveling techniques (shifting, reversing, scrambling, and inversing) according to the determined data type, or determine whether to divide the subpages, the number of subpages to be divided, or an allocation technique of one or more bits depending on the state levels of the memory cell, based on a predetermined algorithm.

The control module 303 may be implemented as firmware. For example, the ware control module 303 may be included in the flash translation layer (FTL). Herein, the flash translation layer is the system software that manages the erase/write/read operation in order to use the flash memory 302 like the hard disk as described above. The flash translation layer may perform subpage division, voltage control, mapping information management, bad block management, data preservation management in unexpected power interruption, abrasion level management, and the like.

The programming module 304 may write the data bits to be written in one page according to control of the control module 301. In more detail, the programming module 304 may apply the driving voltage level value for expressing one or more bits to the memory cell according to a voltage value determined by the control module 301. Further, the programming module 304 may sequentially write data in the divided subpages. Additionally, the programming module 304 may perform the erase operation of the memory cell in response to a subsequent writing request when all of a plurality of state levels of the memory cell are used. Further, the programming module 304 may perform the erase operation of the memory cell in response to the subsequent writing request when all subpages in the page are used. As described above, the programming module 304 may write data in a user area of the flash memory 302 or erase data from the user area. When the write and/or erase operation is performed, the programming module 304 may change the meta data (for example, in-cell write information, erase count or write mode count) stored in the meta area 306 of the flash memory 302.

In an aspect of the present invention, the reading module 305 may read the data written in the user area of the flash memory 302. The reading module 305 may read the data written in the user area based on mapping information between the logical address and the physical address by referring to the data stored in the meta area 306. That is, the reading module 305 may analyze information read from the physical address as an appropriate logical address by referring to the write mode count, the in-cell write mode information, the voltage state level of the memory cell, the mapping information, and/or count information stored in the meta area 306.

The flash memory 302 according to an aspect of the present invention may include the meta area 306 and the user area.

In an aspect of the present invention, the meta area 306 may store the meta data (alternatively, control data) for managing the flash memory 302. The meta data may include the in-cell write mode information, the write mode count information, and the mapping table. The meta area 306 may include at least one physical block constituted by a plurality of physical pages having a plurality of memory cells.

Additionally, the meta area 306 may be integrated in the user area. In this case, for example, the meta data such as the in-cell write mode information and/or count information will be stored in a page 309 or a block 308 of the user area. Additionally, the meta data may be stored in a header (not illustrated) of the page 309 or the block 308 of the user area.

The user area may represent a data storage of a general flash memory. The user area may include at least one physical block constituted by a plurality of physical pages having a plurality of cells.

As illustrated in FIG. 3, one page 309 of the user area of the flash memory 302 may include the plurality of memory cells 310. Each of the memory cells 310 may express three or more different states according to the driving voltage level value. For example, when the memory cell 310 is the MLC, the memory cell 310 may express four different states. Further, when the memory cell 310 is the TLC, the memory cell 310 may express eight different states. In FIG. 3, three states (state 0, state 1, and state 2) are illustrated, but it will be apparent to those skilled in the art that three or more various states may be present through a set-up for the memory cell 310.

Additionally, although not illustrated in FIG. 3, one page 309 may be divided into the plurality of subpages.

In an additional aspect of the present invention, although not illustrated, the memory controller 301 may determine at least one of a type (Data_type) of data to be written, a file size (Data_size) including the data to be written, and a read count (Read_count) for each of the plurality of pages. The decision may be performed by the wear leverer 303 of the memory controller 301, the programming unit 304, or a predetermined other unit (not illustrated). Then, the memory controller 301 may select one ECC among a plurality of error correction codes (ECCs) having different levels based on the decision. Next, the selected ECC may be applied to data to be written.

The ECC may include various levels such as 1-bit error detection and correction or 3-bit error detection and correction. In general, as the number of detected and corrected error bits increases, calculations for processing the error bits and added redundancy may increase. Therefore, trade-off between “accurate error detection and correction” and “a decrease of a load in a memory system” may be present. As a result, the memory controller 301 may determine a type of ECC to be applied to the data based on predetermined factors.

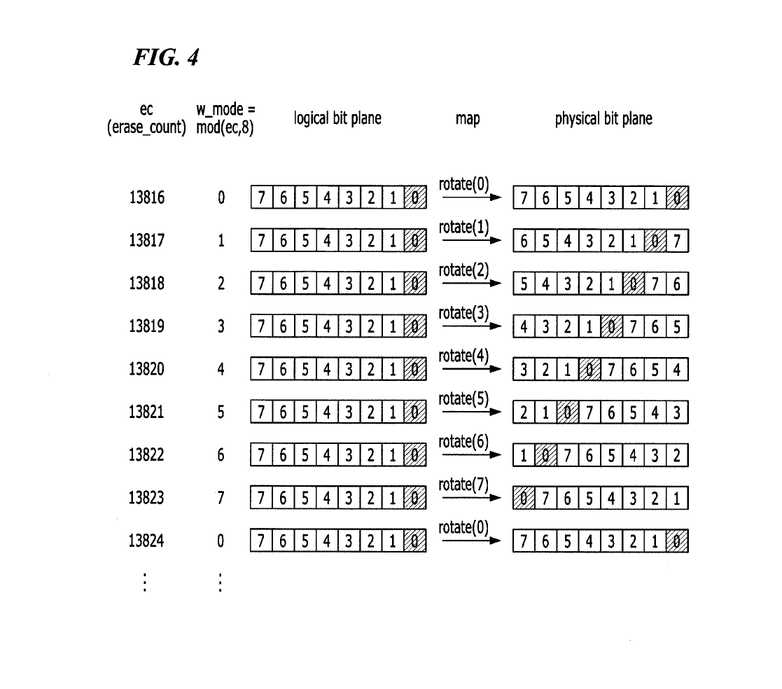

FIG. 4 is a diagram illustrating a method for implementing in-page bit level wear leveling according to an exemplary embodiment of the present invention by using a shifting operation.

As illustrated in FIG. 4, the number of data reset times in one page constituting the flash memory may correspond to the erase count value (erase_count). The in-page write mode (w_mode) may be determined based on the erase count value. For example, the in-page write mode (w_mode) may be “erase count value modulo 8”. For example, when the erase count value is 13816, the in-page write mode may be 0 and when the erase count value is 13817, the in-page write mode may be 1.

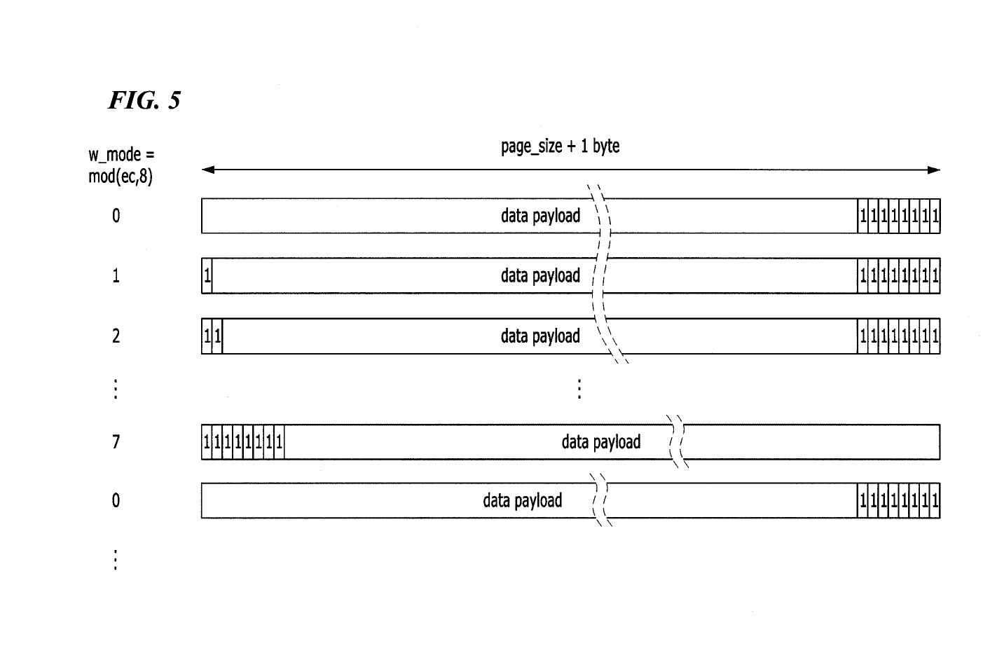

Next, a logical bit plane may be mapped to a physical bit plane according to the determined in-page write mode. As illustrated in FIG. 5, in the logical bit plane, an overwrite operation in one bit is performed, while in the physical bit plane, a write operation may be performed at a bit position shifted in a 1 bit-wise. Therefore, more even distribution of 0 and 1 at bit positions in one page may be achieved.

For example, it is assumed that an English text file is written in a non-volatile memory. As described above, in the English text file, there are many cases in which a most significant bit (MSB) has a value of 0 and there are many cases that bits of bit positions 2 and 3 have a value of 1. When the in-page bit level wear leveling according to the exemplary embodiment of the present invention is implemented, the position of the memory cell in which the MSB is written in one page may be changed according to the change of the in-page write mode. Therefore, since the number of writing times of 0 and 1 is more evenly distributed among the memory cells constituting one page, the bit level wear leveling depending on the in-page write mode may be implemented.

The flash memory may perform reading and writing in the page wise (for example, 512 to 4,096 bytes) and deleting (setting each cell to 1) in the block wise (for example, 16 to 512 kbytes). In general, when the header is present in each block or page, the number of erasing times is logged in the header. The logged number of times may be designated as the erase count (erase_count) value. A rotation number (that is, in-page write mode) may be determined based on the erase count value. The bit positions in the physical bit plane may be rotated (alternatively, shifted) according to the rotational number.

In other words, in-page bit positions of respective data bits to be written in one page may be determined based on the current in-page write mode determined based on the erase count value.

The shifting operation represents shifting bit positions of data payloads. For example, it is assumed that the most significant bit (MSB) is allocated with the bit position of 0 in one byte and subordinated bits are allocated with bit positions which increase by 1. When the shifting operation is implemented, the respective data bits may be shifted to bit positions which are more than bit positions thereof by 1, respectively. A data bit written in the least significant bit (LSB) may be written in the most significant bit (MSB). The shifting operation may be performed in a reverse direction to the aforementioned direction. For example, the respective data bits are shifted to bit positions which are less than bit positions thereof by 1, respectively and the data bit written in the most significant bit (MSB) may be written in the least significant bit (LSB).

Additionally, a bit position identifier identifying in-page positions of the memory cells may be granted to the respective memory cells constituting the page. The memory controller 301 grants the bit position identifiers to the data bits to be written in the page to adjust a writing order of the data bits in the page by a scheme different from the general scheme. As a result, the memory controller 301 may more evenly distribute the number of times 0 is written in the respective memory cells that are present in the page. For example, the memory controller 301 may implement wear leveling of the memory cells in the page by scrambling, shifting, or reversing the data bits to be written in one page.

The aforementioned bit position identifier as a virtual concept is used to indicate the positions at which respective bits are to be written when the memory controller 301 writes the data bits in one page according to the exemplary embodiment of the present invention and an actual bit position identifier may not be implemented or stored. For example, the memory controller 301 does not store a separate bit position identifier table but just performs the shifting operation, the reversing operation, and the scrambling operation of the data bit to be stored in the page to implement the wear leveling of the in-page memory cells.

In an additional aspect of the present invention, write position information regarding the respective data bits written according to the allocated in-page bit positions may be stored in the table. In this case, the page in which the data bits are stored may be read by referring to the write position information stored in the table. Further, the page in which the data bits are stored may be read by referring to not the positional information in the separate table but a counter value.

Additionally, 1 byte (that is, 8 bit)-wise rotation is illustrated in FIG. 4, but it will be apparent to those skilled in the art that various wises of rotations including 4 bit-wise rotation may also be included in the scope of the present invention.

FIG. 5 illustrates a data structure for one page in which micro wear leveling is performed according to an aspect of the present invention.

Referring to FIG. 5, for example, 1 byte may be added to and reserved in one page size (for example, 512 to 4,096 bytes). The plurality of respective pages may additionally include spare bits and offsets of the bits may be given at a write start pointer according to the in-page write mode. The added byte may be designated as a bit shifter. The 8-bit bit shifter will be overhead which may be disregarded in implementing software or hardware. Further, the size of the bit shifter for each page may be variable like 4 bits, 8 bits, or 16 bits.

The spare bits may be determined according to the number of in-page write modes according to the exemplary embodiment of the present invention. For example, when the memory controller implements the in-page bit level wear leveling by using 8 in-page write modes, at least 8 spare bits may be added to the page.

As illustrated in FIG. 5, additional bits are reserved at both ends of a data payload in the page to secure a space to shift the bits for the micro wear leveling. Empty bits which are reserved at both ends of the data payload may be sequentially filled with the value of the binary 1 as the erase operation is performed (that is, the in-page write mode is changed). Therefore, by the additional bits, an overall structure of the data payload may not be changed in implementing the micro wear leveling such as the bit shift, and the like.

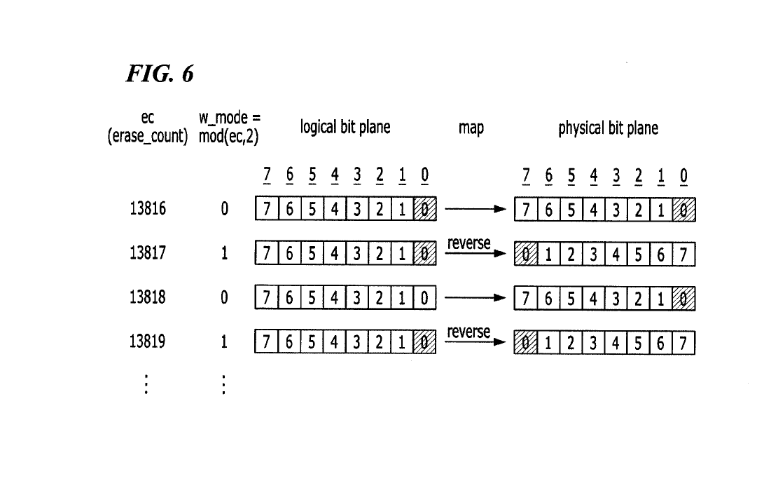

FIG. 6 is a diagram illustrating a method for implementing in-page bit level wear leveling according to an exemplary embodiment of the present invention by using a reversing operation.

In FIG. 4 the micro wear leveling using the rotation (alternatively, shifting) is described. FIG. 6 illustrates a micro wear leveling technique using reversing.

As illustrated in FIG. 6, the memory controller performs the reversing operation of the in-page bit positions allocated according to the previous in-page write mode based on the current in-page write mode to allocate the in-page bit positions to the respective data bits to be written in one page.

The reversing based micro wear leveling technique illustrated in FIG. 6 arranges the bit positions in the order of the MSB or the order of the LSB to be more easily implemented than the micro wear leveling technique illustrated in FIG. 4.

The reversing operation represents placing the bit positions of the data payloads in a reverse order. For example, it is assumed that the most significant bit (MSB) is allocated with the bit position of 0 in one byte and subordinated bits are allocated with bit positions which increase by 1. When the reversing operation is implemented, the least significant bit (LSB) may be allocated with the bit position of 0 and unsubordinated bits from the LSB may be allocated with bit positions which increase from 0 by 1. In this case, the most significant bit (MSB) and the least significant bit (LSB) may be allocated with bit values received before the reversing operation. In other words, the reversing operation may represent an operation that places the in-page bit positions allocated according to the previous in-page write mode based on the determined current in-page write mode in a reverse order. The reversing operation may be performed in a reverse direction to the aforementioned direction.

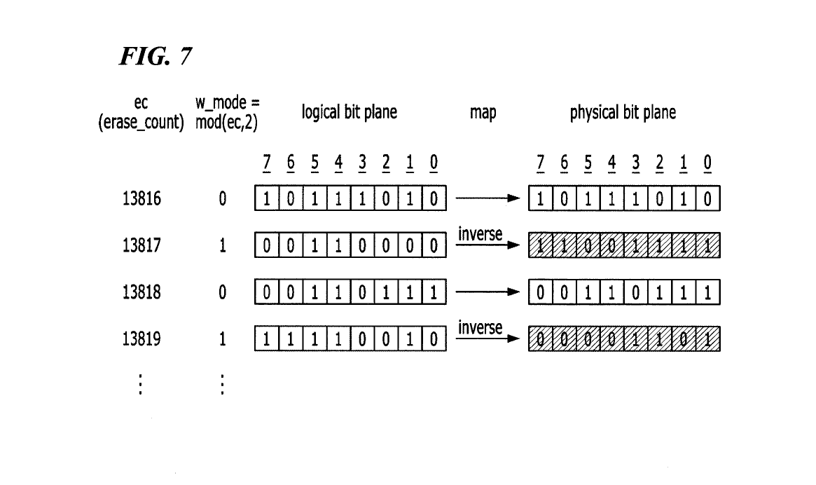

FIG. 7 is a diagram illustrating a method for implementing in-page bit level wear leveling according to an exemplary embodiment of the present invention by using an inversing operation.

The micro wear leveling technique described through FIG. 7 represents a technique that inverts values of written bits.

As illustrated in FIG. 7, according to the in-page write mode, data bit values in the logical bit plane in one page may have inverse values to the data bit values according to the previous in-page write mode. Therefore, the values of the bits to be written are inverted to be mapped to the physical bit plane for each odd-numbered erase count (alternatively, for each even-numbered erase count).

In the case of the inverse based micro wear leveling technique, the in-page write mode (w_mode) may have a value of erase count modulo 2.

In additional aspect of the present invention, although not illustrated in FIGS. 4 to 7, a bit-wise micro wear leveling technique through the scrambling operation or a bit-wise micro wear leveling technique through a hash function may also be included in the scope of the present invention.

For example, the memory controller 301 may mix the values or positions of the data bits to be written in the page according to an order determined according to the in-page write mode. The data bits mixed in the order predetermined by the memory controller 301 are written in the page to make the distribution of 0 and 1 of the bits written in the memory cells constituting the page be more even.

The hash function in the additional aspect of the present invention may represent a function for mapping logical positions and physical positions of the data bits to be written in the page.

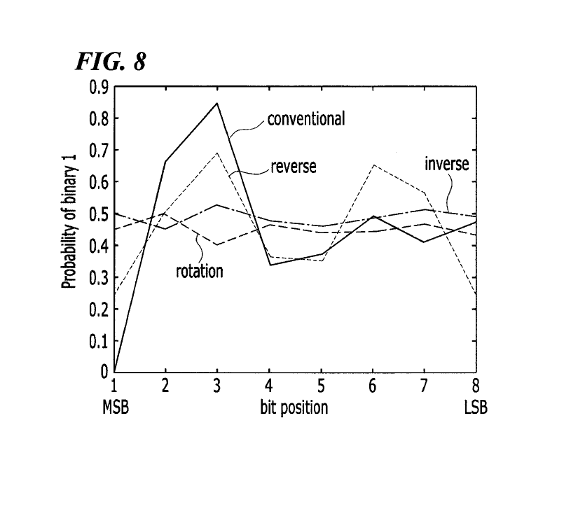

FIG. 8 illustrates a probabilistic distribution of binary 1 for each bit position between micro wear leveling techniques using rotation, reversing, and inversing operations according to an aspect of the present invention and the existing wear leveling technique.

As illustrated in FIG. 8, the probabilistic distribution of binary 1 for each bit position for the micro wear leveling techniques according to an aspect of the present invention may be more even than the existing wear leveling technique.

Therefore, in the wear leveling technique according to an aspect of the present invention, since the erase operation may not concentrate on a specific bit position as compared with the existing wear leveling technique, the erase operation may be evenly distributed to the respective bit positions in the flash memory. As a result, abrasion levels for the respective cells of the flash memory may be reduced. In more detail, when the erase operation is performed 800,000 times at the respective bit positions, low abrasion levels of approximately 39.3%, 22.9%, and 44.3% may be achieved in the case of the rotation, reverse, and inverse based wear leveling techniques as compared with the existing wear leveling technique.

In the case of the micro wear leveling techniques according to the exemplary embodiment of the present invention described above, two or more techniques may be mixedly used. For example, the micro wear leveling technique of shifting the data bit to be written in the page and the micro wear leveling technique of reversing the data bit may be mixedly used. In this case, the in-page write mode may indicate states according to two or more micro wear leveling techniques. For example, the in-page write modes may be defined such as shifting mode 0 in the case of in-page write mode 0, reversing mode 0 in the case of in-page write mode 1, shifting mode 1 in the case of in-page write mode 2, reversing mode 1 in the case of in-page write mode 3, and the like.

In another exemplary embodiment of the present invention, the memory controller 301 may allocate different micro wear leveling techniques and apply the allocated micro wear leveling techniques according to a format of a file. For example, the shifting operation is applied in the case of the English text file and the reversing operation is applied in the case of a Korean text file to allocate the in-page bit level micro wear leveling technique. The memory controller 301 may allocate the micro wear leveling technique according to the format of the file by referring to a predetermined look-up table or analyzing input write data.

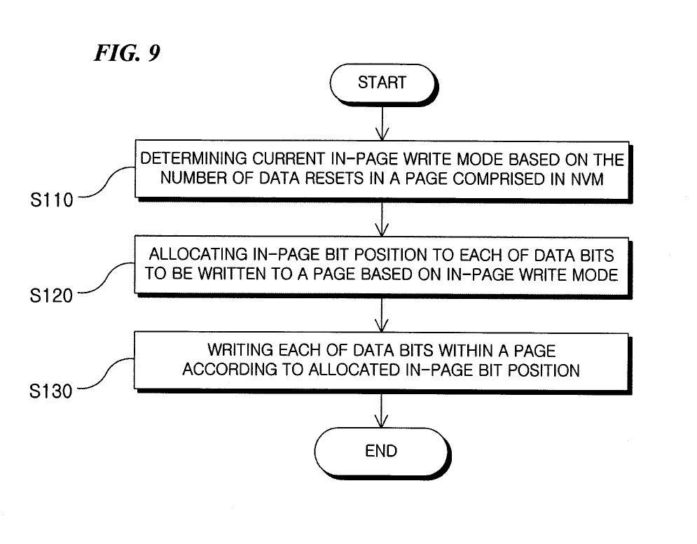

FIG. 9 illustrates an exemplary method for performing wear leveling according to an aspect of the present invention.

It will be apparent to those skilled in the art that additional steps other than steps illustrated in FIG. 9 may be included in a wear leveling method and some steps may be omitted.

As illustrated in FIG. 9, the memory controller for performing the wear leveling may determine the current in-page write mode based on the number of data reset times (that is, erase count or wear count) in one page in blocks constituting a non-volatile memory (S110). As described above, a value of the in-page write mode depending on the erase count value may be determined through a modulo operation.

Next, the memory controller may allocate in-page bit positions to respective data bits to be written in one page based on the determined current in-page write mode (S120). In this regard, bit position identifiers that identify the respective bit positions in one page may be allocated to the respective bit positions in the page. The allocation of the bit position or the allocation of the bit position identifier may be performed based on at least one of the rotation operation (alternatively, shifting operation), the reversing operation, and the scrambling operation as described above. In more detail, the memory controller performs at least one of the rotation operation, the reversing operation, and the scrambling operation at the in-page bit position allocated according to the previous in-page write mode based on the determined current in-page write mode to allocate the in-page bit positions to the respective data bits to be written in one page.

Additionally, the respective pages in the block may include spare bits having a predetermined size in order to perform the rotation operation or the shifting operation. The memory controller may write the data bits to be written in one page according to the allocated in-page bit position (S130).

In the additional aspect of the present invention, the memory controller may invert values of respective data bits according to the previous in-page write mode based on the determined current in-page write mode. Next, the memory controller may write the respective data bits having the inverted values in one page.

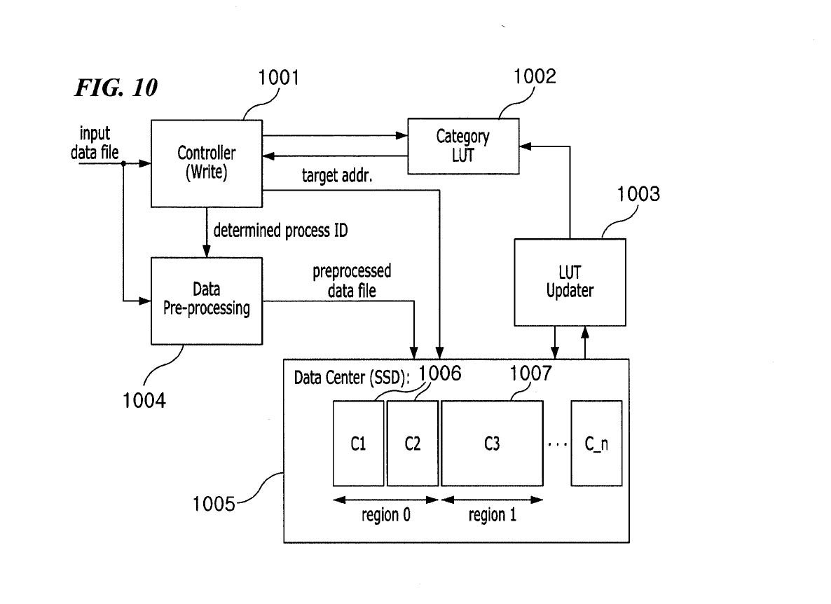

FIG. 10 illustrates an exemplary memory system for implementing data writing dependent on a data type according to an aspect of the present invention.

In respect to the non-volatile memory such as the flash memory, since writing 0 requires higher voltage or current than writing 1, the service life of the memory cell may be correspondingly shortened. Therefore, the need for reducing the number of 0s in data is present in the art.

In the flash memory, since writing 0 generally requires a longer time than writing 1, when more 0s are present as write data values, a time required for writing is extended.

In this regard, a technique may be considered, which inverses or compresses the value of the data to be written may be considered when the number of 0s is more than a predetermined threshold or when the number of 0s is more than the number of 1s by counting values of 0 in data to be written. In such a technique, a flag needs to be stored, which is used for analyzing and counting the values of 0s and/or 1s with respect to respective inputs and indicating whether a specific block (alternatively, page or memory cell) needs to be inverted or compressed.

Additionally, as a method for reducing the number of 0s in writing data, “lossless compression” may be considered. The reason is that an overall size of the data to be written may be reduced. However, in general, since compression may apply an excessive load to the memory controller, the compression may exert a bad influence on the performance of the memory. The reason is that when the compression is performed while writing the data, decompression needs to be performed every time in order to read the compressed data. Further, since large-volume files such as a video file are generally files of a format which is compressed in advance, the compression may not be performed in writing the data. Therefore, a method for minimizing a burden on the memory controller by determining whether the files need to be selectively compressed may be considered. Moreover, methods such as changing complexity of an ECC according to characteristics of input data or applying different writing methods may also be considered.

Table 1 given below shows result values from a test that observes selective or unconditional inversion according to respective file extensions.

TABLE 1

| | Gain by unconditional | Gain by selective |
|---|---|---|
| File extension [symbol] | inversion [symbol] | inversion [symbol] |
| doc1 [symbol] | 59.6% [symbol] | 62.2% [symbol] |
| xls1 [symbol] | 50.5% [symbol] | 50.9% [symbol] |
| xls2 [symbol] | 30.9% [symbol] | [symbol] |
| xlsx [symbol] | 25.0% [symbol] | [symbol] |
| ppt [symbol] | 17.3% [symbol] | 18.6% [symbol] |
| pptx [symbol] | 14.6% [symbol] | [symbol] |
| doc2 [symbol] | 14.3% [symbol] | [symbol] |
| docx [symbol] | 11.9% [symbol] | [symbol] |
| txt(ASCII) [symbol] | 9.3% [symbol] | 9.3% [symbol] |
| txt(UTF8) [symbol] | 4.7% [symbol] | 4.7% [symbol] |
| pdf [symbol] | 2.1% [symbol] | 3.0% [symbol] |
| wav [symbol] | 0.8% [symbol] | 2.3% [symbol] |
| mp3 [symbol] | 0.6% [symbol] | 2.4% [symbol] |
| jpg [symbol] | −0.5% [symbol] | 1.1% [symbol] |
| zip [symbol] | −1.4% [symbol] | 1.0% [symbol] |
| avi [symbol] | −5.2% [symbol] | 0.8% [symbol] |

[Results of Inversion Test]

Gain values in Table 1 are determined through an equation of 100×(No. of ‘0’ in original—No. of ‘0’ in inversion)/Total No. of bits.

As shown in Table 1, in specific file types, reduction for ‘0’ of a maximum of approximately 60% may be achieved through the unconditional bit inversion. Moreover, as shown in Table 1, when the bit is inverted by counting the number of 0s or 1s of the data in the block (that is, selective inversion), it is revealed that a difference in gain value between the selective inversion and the unconditional inversion is not large. Therefore, the unconditional bit inversion may reduce the load of the memory controller caused in counting the value of 0 or 1. Further, referring to Table 1, it may be recognized that a large difference between the gain values is present according to the file type. For example, in compressed files such as mp3, jpg, zip, and avi, it may be determined that a degree of the gain by the inversion is low due to an entropy coding feature.

Therefore, based on the test result values, a bit inversion or compression method based on a file extension (that is, data pattern) according to an aspect of the present invention is presented below. In such a method, a high gain value and low-level overhead cost may be simultaneously achieved as compared with a method of compressing or inverting all data files or a method of compressing or inverting 0 by analyzing the number of 0s.

Referring back to FIG. 10, an input data file may be inserted into a memory controller 1001 and a data pre-processor 1004. As described below, through the data pre-processor 1004, the service life of the flash memory may be prolonged and power consumption required in reading and writing processes may also be reduced.

An algorithm according to an aspect of the present invention presents a technical feature in that input data is mapped with a target pre-processor based on a look-up table (LUT) 1003. In more detail, file attributes for the input data may be determined based on the file extension. Information regarding the determined file attributes may be mapped with a specific process ID. For example, a data file of a specific type or format may be mapped with an “inverse process”. For example, a data file of a specific type or format may be mapped with a “compressing process”. Information regarding the mapping may represent information for causing specific processing to be performed when data of a specific format is input. Mapping information between an ID of the process and an attribute of the data may be stored in the look-up table 1003 for pre-processing the input data. This may be performed between a user access application layer and a disk access layer. Alternatively, this may be applied in a data storage or a data center such as a cloud storage. Alternatively, this may be applied at an OS or FTL level for a mobile/desktop device.

Referring back to FIG. 10, the memory controller 1001 may determine a process identifier (ID) and a target address by referring to the information stored in the look-up table 1002 when receiving the data file. For example, the process ID may correspond to “C1: Compress,” “C2: Inversion,” “C3: By-pass (No-process)” . . . , and “Cn: Special process”. The memory controller 1001 may transfer the mapping information (alternatively, process ID information) received from the look-up table 1002 to the data pre-processor 1004. Additionally, the memory controller 1001 may perform data transformation based on the file attribute determined by the file extension. This may be implemented in the FTL during the write operation. For example, when a file having an extension of ppt is input, the memory controller 1001 may perform transformation of bit inversion by referring to the look-up table 1002. Further, when a file having an extension of zip is input, the memory controller 1001 may bypass the zip file.

The data pre-processor 1004 may create a pre-processed version of the input data file based on the information received from the memory controller 1001. For example, the data pre-processor 1004 may invert the input data values based on the information received from the memory controller 1001. Moreover, the preprocessing information of the input data may be stored in a data center (SSD 1005). The data file of the preprocessed version may be written in the data center (SSD 1005). The data center according to an aspect of the present invention may include various data storage media including the non-volatile memory.

In an aspect of the present invention, the data file of the preprocessed version may be written in a target area C1 to Cn of the data center 1005. A target address for designating the target area may be included in a signal transferred from the memory controller 1001 to the data center 1006. Therefore, the preprocessed input data may be written in the data center 1005 according to the target address.

The target area in the data center 1005 may be allocated in a process ID wise. In more detail, data corresponding to the same process ID may be written in the same area. Therefore, the target area may identify the process ID. Therefore, allocating written areas in the data center 1005 in the process ID wise may permit, for example, a process in which inverse processing is performed to be easily determined in reading the written data.

In an aspect of the present invention, respective C1, C2 . . . , Cn may represent the blocks or pages in the flash memory. Alternatively, the respective C1, C2 . . . , Cn may represent individual data servers. Further, for example, as illustrated in FIG. 10, C1 and C2 are grouped to be allocated to area 0 1006 and C3 may not be grouped but C3 itself may be allocated to area 1 1007.

According to an aspect of the present invention, since a target process at the time of reading the data may be identified only with the physical address in which the data is written, I/O and overhead for reading the data may be reduced. Additionally, the areas written in the process ID (alternatively, data pattern) wise are differently allocated to achieve an additional wear leveling effect.

For example, when the file pattern is Doc, the write/erase operation may be performed more frequently than the write/erase operation when the file pattern is Avi. In this case, when an area in which the file pattern of Doc is written and an area in which Avi is written are changed, the wear leveling may be achieved. For example, when data corresponding to C1 (for example, process ID, compression) and data corresponding to C3 (process ID, bypass) are changed with each other, the wear leveling may be achieved. The reason is that data of different file types have different write/read frequencies, data sizes, and ratios of the values of 0s.

In an aspect of the present invention, a look-up table updater 1003 may optimize the performance of the look-up table 100 through intermittent off-line update. For example, the look-up table updater 1003 periodically or aperiodically evaluates the process ID for the specific file format to change mapping information between the specific file format and the process ID. Further, when a new type file is input, the look-up table updater 1003 performs gain value calculation and analysis of the number and distribution of 0s (alternatively, 1s) to determine an optimal process ID for the corresponding type data file. Moreover, the look-up table updater 1003 communicates with the data center 1005 to transfer the wear leveling information, the mapping information, and the like to the look-up table 1002. Additionally, the look-up table updater 1003 may be integrated into the look-up table 1002 or the data center 1005.

In an additional aspect of the present invention, although not illustrated in FIG. 10, the memory controller 1001 may combine and use a reversing technique based on a method for detecting the number of 0s (alternatively, 1s) for input data and a reversing technique according to an input file. For example, the memory controller 1001 detects the values of 0 for the input data with respect to a data file of a type which is not stored in the look-up table 1002 to create the process ID. Mapping information between the newly created input data and the process ID may be stored in the look-up table 1002 for later search.

Since technical features disclosed in the present specification according to FIG. 10 perform still less compressions than a mechanism (compress-all mechanism) in which compression is unconditionally performed, for example, cost consumed in the reading process may be significantly reduced. Further, the technical features disclosed in the present specification may obtain a gain value of a similar degree while performing simpler decision than a mechanism that selectively performs reverse processing by analyzing the number of 0s (alternatively, 1s) of the input data. Therefore, the technical features disclosed in the present specification may efficiently increase the service life of the flash memory through low calculation complexity and simple implementation.

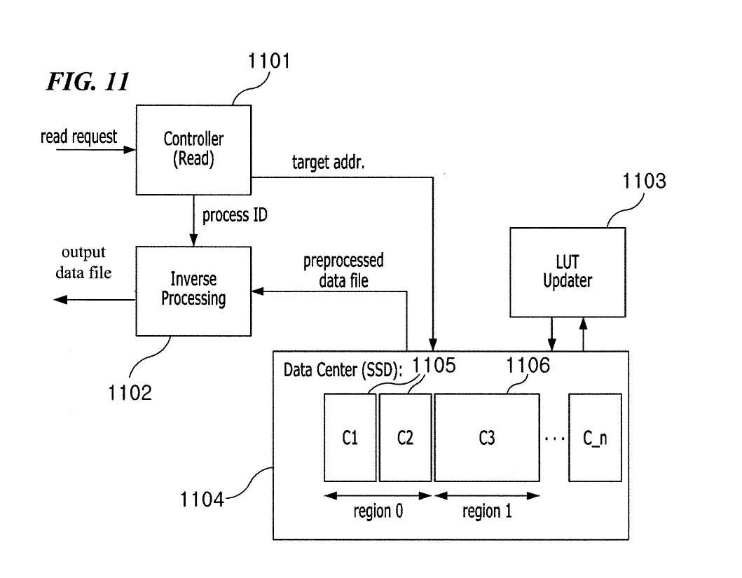

FIG. 11 illustrates an exemplary memory system for reading data written dependently on a data type according to an aspect of the present invention.

As illustrated in FIG. 11, when a data reading request is input into a memory controller 1101 from a host or an application, the memory controller 1101 determines a type of data of which reading is requested to transfer the target address to the data center 1104 and determines the process ID according to the determined data type to transfer the process ID to the inverse processor 1102. In an aspect of the present invention, the inverse processor 1102 and the pre-processor 1004 may be integrated into one processor.

In an aspect of the present invention, the data center 1104 may include process ID wise areas (for example, area 0 1105 and area 1 1106) as described in FIG. 10. The data center 1104 receives target address information from the memory controller 1101 to transfer data file information (alternatively, process ID information) preprocessed according to the corresponding address to the inverse processor 1102. That is, since the areas of the flash memory are allocated in the process ID wise, the data center 1104 may determine the format of the corresponding data and the process ID based on only the target address information. Further, the data center 1104 communicates with the look-up table updater 1103 to modify mapping information between the format of the data file and the process ID.

The inverse processor 1102 may create an output data file corresponding to the reading request based on the preprocessed data file received from the data center 1104. The created output data file may be transferred to the application or the host.

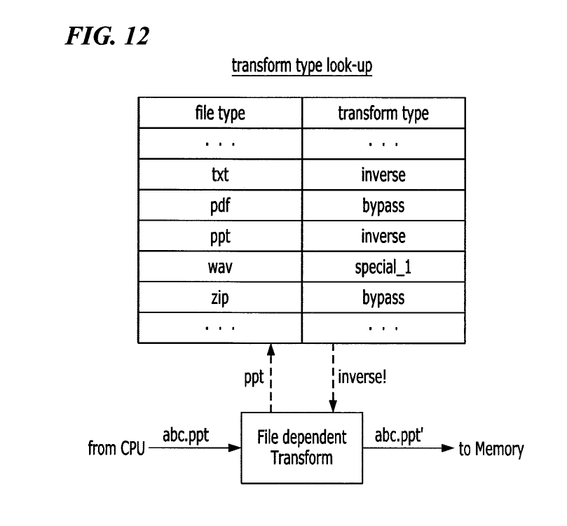

FIG. 12 exemplarily illustrates a file subordinated transformation process using mapping information between a file type and a transformation type stored in a look-up table according to an aspect of the present invention.

Referring to FIG. 12, the inverse process as the process ID is mapped to the data files having text and ppt extensions, the bypass process as the process ID is mapped to data files having pdf and zip extensions, and a special_1 process as the processor ID is mapped to a data file having a way extension. That is, transformation processes other than the inverse process may be present and the point that the other transformation processes may also be mapped to an appropriate file type will be included in the scope of the present invention.

As illustrated in FIG. 12, when the data file having the ppt extension is input from the host such as a CPU, the file subordinated transformation system may find a transformation type (that is, inverse) mapped with the file having the ppt extension in the look-up table. As a result, the file subordinated transformation system applies the transformation process of the corresponding transformation type to the corresponding file to write data in the flash memory.

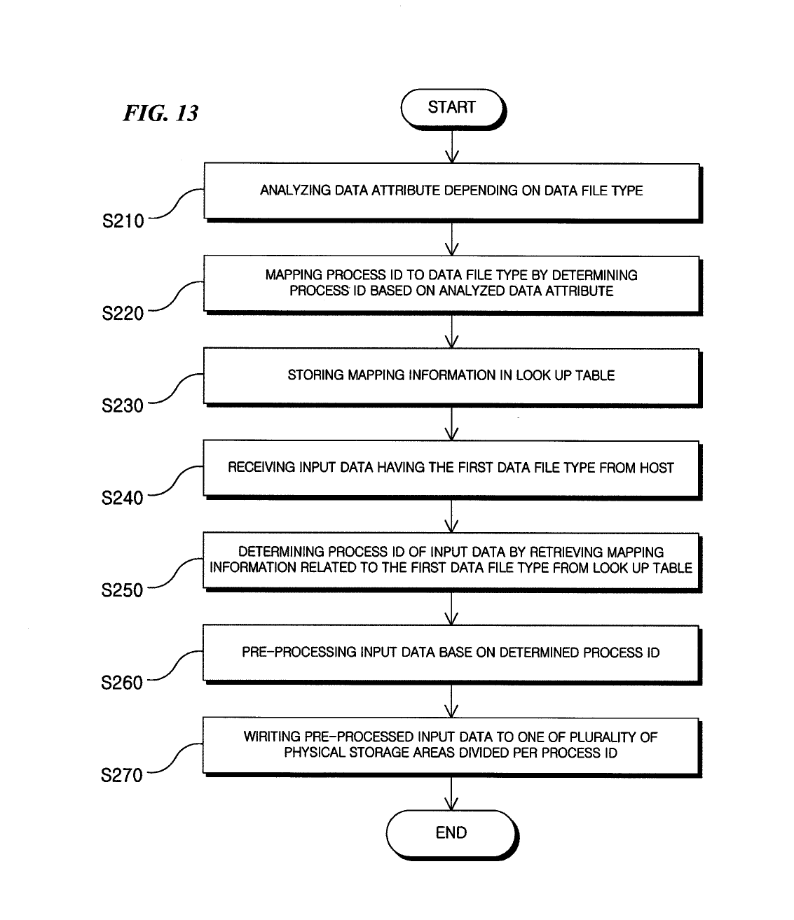

FIG. 13 illustrates a data writing method through the file subordinated transformation process according to an aspect of the present invention.

It will be apparent to those skilled in the art that additional steps other than steps illustrated in FIG. 13 may be included in the method and some steps may be omitted.

As illustrated in FIG. 13, the memory controller may analyze a data attribute according to the data type (S210). In more detail, the memory controller analyzes attributes for data files having specific data types (that is, extension) to determine whether predetermined transformation such as inversion of values of 0 and 1 is required.

Next, the memory controller may determine a process ID suitable for a specific data type based on the analyzed data attribute (S220). In more detail, the memory controller may map the data type and the process ID. Next, the mapped information may be stored in the look-up table (S230).

When data having a specific data type is input (S240), the memory controller may determine the process ID for the input data type based on the mapping information stored in the look-up table (S250). In more detail, the memory controller searches the mapping information associated with the corresponding data file type from the look-up table to determine how the input data is transformed.

Next, the memory controller (alternatively, processor) may pre-process (for example, invert) the input data according to the determined process ID (S260). The pre-processed data may be written in specific physical areas in the flash memory, which are divided according to the process ID (S270).

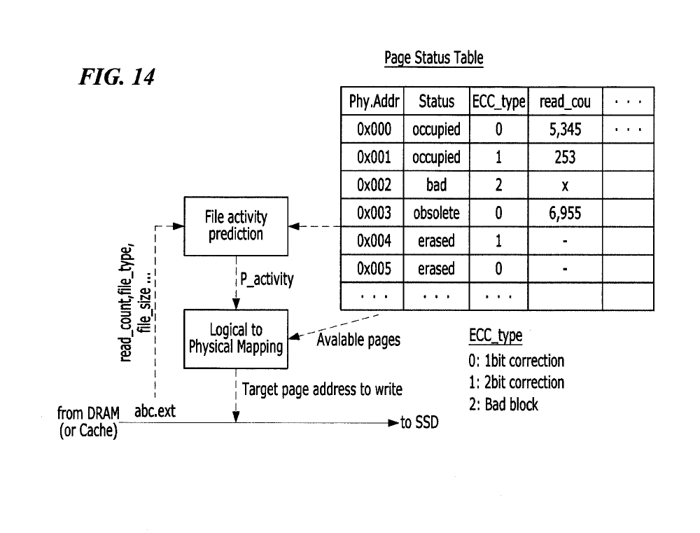

FIG. 14 illustrates a data allocation algorithm considering an ECC type according to an aspect of the present invention.

An error correction code (ECC) may be used to detect and correct errors which occur according to a write-erase cycle. As the number of error bits which may be detected and corrected in the ECC increases, the quantity of operations for processing the increase and the quantity of redundancies to be added also increase. The level of the ECC may represent a capacity to detect and/or correct a data error. A high-level ECC may cause a large load to be applied to the FTL. Therefore, in order to optimize overhead cost, the need for differently controlling the level of the ECC based on a state of the block (alternatively, page) and the like is present in the art.

The algorithm illustrated in FIG. 14 may be generally performed by the memory controller. The memory controller may implement mapping from a logical sector to a physical page based on the ECC level and a predicted reading frequency in each target page.

The existing technologies determine a physical page in which an erase count value is small among available physical pages as a target physical page according to a wear leveling policy to implement mapping between the logical sector and the target physical page. However, the mapping according to an aspect of the present invention may determine the target physical page by additionally referring to information on the ECC type. Therefore, for example, hot data (file) may be allocated to a page coded to an ECC having a low level and cold data (file) may be coded to an ECC having a high level.

Referring back to FIG. 14, a page status table shows various statuses (for example, read_count and status) including the ECC type (ECC_type) with respect to respective page addresses (Phy.Addr). The page status table may be stored in the volatile memory as for example, a cache. Alternatively, the page status table may be stored in the non-volatile memory such as the flash memory.

In an aspect of the present invention, the ECC type may represent a level to determine how many bit errors are corrected and/or detected in the corresponding pages. For example, when ECC_type is 0, this represents that an ECC to detect up to a 1-bit error will be used because an error cell is not present. Further, for example, when ECC_type is 1, this represents that an ECC to detect a maximum of 2-bit error will be used because the 1-bit error is already present. As another example, when ECC_type is 2, this represents that the page is defined as a bad block because an error of 2 bits or more is present in the page. The bad block may represent a memory area which is not used. In the present invention, three types of ECC levels are defined, but it will also be apparent to those skilled in the art that an additional type of ECC level other than three types may be present.

The memory controller may create the page status table associated with information on respective pages in an initial step. Information stored in the page status table may include information on the number of reading times (read_count) information regarding a specific page, status information (for example, whether the specific page is in an occupied state, in an obsolete state, in a state in which the page is processed as the bad block, or in an erased state) regarding the specific page, and ECC type (ECC level) information regarding the specific page. Herein, the ECC level may be determined based on whether the page is a hot page (that is, whether the page is a page of which the read count is large) and a current state of the page. For example, the ECC type of the page of which the read count is large may be set to be lower than that of a page of which the read count is small (that is, an ECC having a small capacity). Further, the type of the ECC when the page is processed as the bad block may be set to be higher than that when the page is not processed as the bad block (that is, an ECC having a large capacity).

When the memory controller receives the writing/reading request from the host, the memory controller may perform mapping to the physical page from the logical sector through file activation prediction by referring to the page status table stored in a DRAM or cache. That is, the memory controller may determine an appropriate page based on the page status table. For example, the ECC page having a low level may be allocated to data which may be periodically read. Herein, the file activation prediction (P_activity) may represent a future probability of read and be determined based on the previous read count (read_count) of data. Further, when the read_count is not present, the file activation prediction may be determined based on other factors (for example, file_type, file_size, and the like). Further, herein, the read_count may be used commonly with the wear leveling process.

Table 2 given below exemplarily illustrates an ECC type for each ECC processing wise.

TABLE 2

| [symbol] | [symbol] | [symbol] |
|---|---|---|
| Phy.Addr [symbol] | Bad_page_flag [symbol] | ECC_type_256B [symbol] |
| 0x000 [symbol] | 0 [symbol] | 00000000 [symbol] |
| 0x001 [symbol] | 0 [symbol] | 00100010 [symbol] |
| 0x002 [symbol] | 0 [symbol] | 01100100 [symbol] |
| 0x003 [symbol] | 1 [symbol] | — [symbol] |
| . . . [symbol] | . . . [symbol] | . . . [symbol] |

[ECC Type for Each ECC Processing Wise]

Herein, it is assumed that 1 page=2 KB-256 B×8.

As presented in Table 2, for example, page 0x000 may be an error-free page and an ECC type having a higher level may be applied to page 0x001.

Therefore, in the present invention, since the level of the ECC is differently applied according to the quantity/positions of errors and the read count, the quantity of required operations and power consumption may be minimized. This may correspondingly improve average input output per second (IOPS) in the flash memory (for example, SSD).

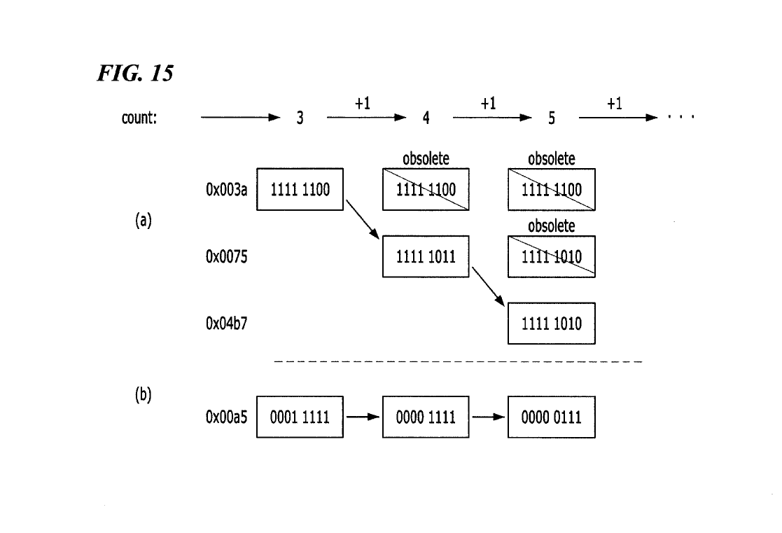

FIG. 15 illustrating a data format related with a count operation in the SSD according to the related art and a data format according to an aspect of the present invention.

Due to the advantage of the aforementioned SSD, it is a current trend to change a disk in a data center to the SSD. Through the trend, in the data center adopting the SSD, a physical size of the server may be reduced and power consumption may also be reduced.

A Map-Reduce process which is a programming model for processing a large amount of data sets in a cluster or a cloud generally requires a mass storage for counters and indexes. When the number of data to be counted is large, it is impossible that a memory to store all the counters resides in a cache. In the SSD including the flash memory, “overwriting in place” is impossible, and newly increased count values need to be written in a new page in the SSD.

Since many web services update a large amount of statistic data in real time, the counters need to be updated in real time in order to reflect the updated statistic data. Accordingly, the counter may become a main cause to lower IOPS of the SSD and reduce the lifespan of the SSD. Therefore, a count strategy in the SSD which may admit a simple increase in the counters without delete-overwrite processes may be required in the art.

In order to improve storage performance of the SSD, a change related with data formatting in the application or the OS level may be considered.

Referring back to FIG. 15, methods for increasing counters in the SSD for (a) the existing invention and (b) the present invention are compared with each other. In the case of the existing invention, a new page is used in order to store a value increased by 1 wise to have a bad effect on the lifespan of the SSD. Further, as described above, in order to store a large amount of counter values, using the new pages may also unnecessarily waste the SSD storage.

According to an aspect of the present invention, the count data may be stored as 1 count per 1 bit in the data format dedicated to storing the count. That is, the count value may be allocated to each of the plurality of bits in one page. “In-place update” is possible by implementing the data format. However, “one page” may be too small to store a large quantity of count values.

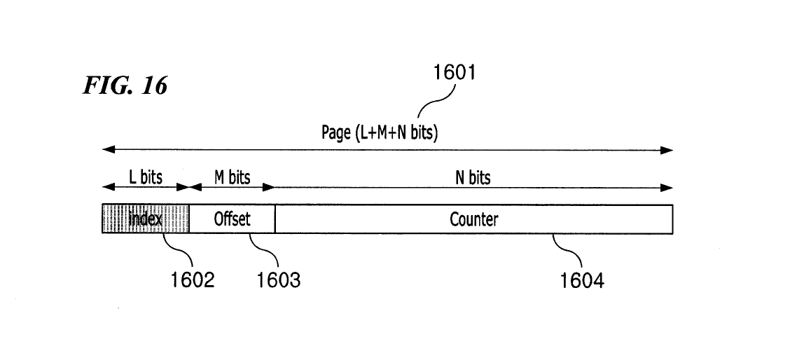

In order to solve the disadvantages, in FIG. 16, an improved data format is proposed.

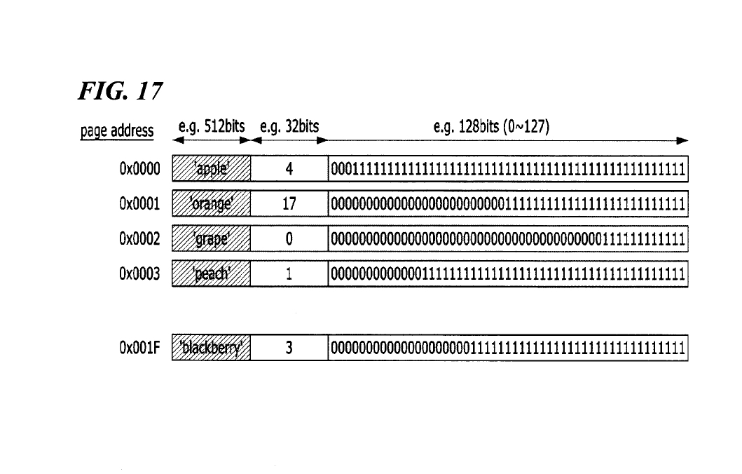

FIGS. 16 and 17 illustrate data formats for storing count values according to an aspect of the present invention.

Referring to FIG. 16, one page 1601 may be divided into three segments. That is, one page 1601 may include an index 1602 constituted by L bits, an offset 1603 constituted by M bits, and a counter 1604 constituted by N bits. The data may be stored at different formats for respective fields.

In an aspect of the present invention, the index 1602 may represent, for example, a field for storing a text corresponding to “key” in operations such as Map-Reduce. Further, the offset 1603 may represent a field storing the counter in hexadecimal. Further, the counter 1604 may represent a field in which the counter may be stored by the 1-bit-wise. The sizes (that is, L, M, and N) of the index 1602, the offset 1603, and the counter 1604 may be variable, respectively.

Accordingly, the index 1602 may represent, for example, keywords such as search words. Further, when all of the bits values in the counter 1604 are used as the counter values, the counter value may be newly used from the most significant bit in the counter 1604 field while increasing (for example, by 1) of the value of the offset 1603. Through the type of data format, a capacity which may store the counter values in the SSD may be maximized.

Referring to FIG. 17, the data format in FIG. 16 will be described with a more detailed example.

As illustrated in FIG. 17, in one page, the index 1602 field may be composed of, for example, 512 bits, the offset 1603 field may be composed of 32 bits, and the count 1604 field may be composed of 128 bits.

The index 1602 field may include “keys” such as ‘apple’, ‘orange’, ‘grape’, ‘peach’, and ‘blackberry’. Accordingly, for example, the current apple is counted to 4×128+3. That is, in the count 1604 field, since the current apple is counted to 1->0 three times and the offset 1603 field has a value of 4, 128 counts are performed four times. In other words, when all of the counts of 1->0 of a 1-bit-wise in the count 1604 field are performed, the count 1604 field is reset and the offset 1603 field is increased by 1. The value of 1 in the offset 1603 in the example may represent that 128 counts are performed.

In the following Table 3, a data format according to an aspect of the present invention and a data format in the related art are compared with each other.

TABLE 3

| | | proposed | #erase | #erase |
|---|---|---|---|---|
| index | count | expression | (proposed) | (related) |
| apple | 515 | 4 × 128 + 3 | 4 | 515 |
| orange | 2249 | 17 × 128 + 73 | 17 | 2249 |
| grape | 89 | 0 × 128 + 89 | 0 | 89 |
| peach | 143 | 1 × + 15 | 1 | 143 |
| blackberry | 424 | 3 × 128 + 40 | 3 | 424 |

[Comparison of the Number of Erase Times According to Data Formats in the Related Art and the Present Invention]

As illustrated in Table 3, in the case of the data format for the SSD in the related art, whenever the new count occurs, a new page needs to be allocated and thus, the delete number of times is also largely increased. However, in the case of a new data format of the present invention, the count value is increased by a bit-wise and thus, the delete number of times may be largely reduced. That is, the data format according to the aspect of the present invention may permit in-place update by a length of the counter field. Accordingly, the data format according to the aspect of the present invention may be continuously programmed (written) in the same page without deleting.

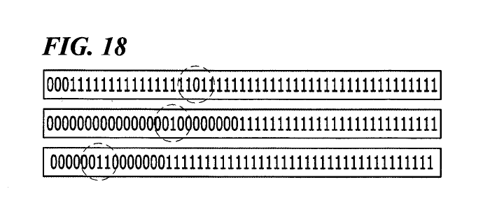

FIG. 18 illustrates a bit error for the data format according to an aspect of the present invention.

In the case of setting the count value by a 1-bit-wise in the page, the setting may influence adjacent cells. Due to a physical arrangement of the cells, an error generated in one cell may be generated in neighboring cells. For example, as illustrated in FIG. 18, data at a portion illustrated by a circle may represent data with the generated error. Errors exemplified in FIG. 18 may be easily detected and corrected without using a complicated ECC algorithm (that is, a high-level ECC algorithm) because different bit values are present therearound.

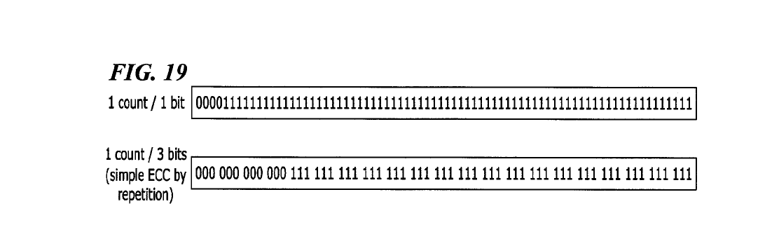

FIG. 19 illustrates a data format in which bit error correction is easy according to an aspect of the present invention.

The simple error illustrated in FIG. 18 is easily detected and corrected, but when the error is generated on a boundary of 0 and 1, a higher-level ECC algorithm may be required. In this case, the overload in the system may be caused due to the high-level ECC algorithm.

As a method for solving the problem, the data format for writing a count value by a three-bit-wise is proposed in FIG. 19. As illustrated in FIG. 19, in the case of a count writing method of a 1-bit-wise, when the error generated on the boundary of 0 and 1 is detected, the problem may occur. However, in the case of a count writing method of a three-bit-wise, the error generated on the aforementioned boundary may also be easily detected and corrected. Accordingly, when the data format illustrated in FIG. 19 is decoded, bit errors may be detected and corrected without using the ECC algorithm (alternatively, by using only a low-level ECC algorithm), and thus, overhead cost caused by the system may be reduced.

FIG. 19 illustrates a method of writing the count value by a 3-bit-wise, but a method of writing a count value by various bit-wises such as a 4-bit-wise or a 5-bit-wise may also be included in the scope of the present invention.

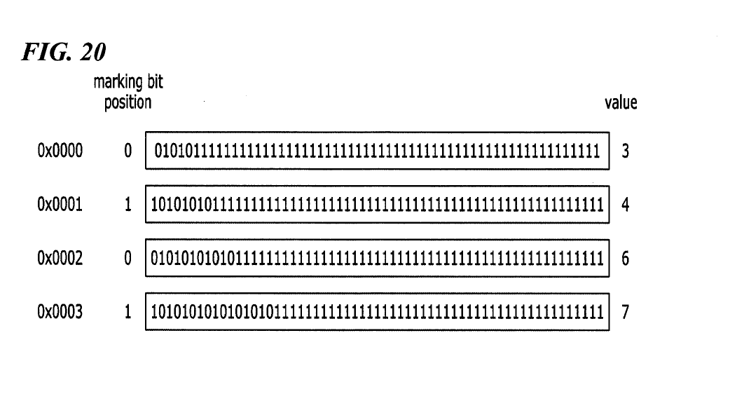

FIG. 20 illustrates a data format in which bit error correction is easy according to another aspect of the present invention.

When a value of a specific cell is changed to 0, a program error in which a value of a neighboring cell is also changed due to the physical arrangement of the cells may be present. Accordingly, in order to minimize the program error, in FIG. 20, for example, a method of writing a count value only in odd-numbered bits in an odd-numbered page and writing the count value only in even-numbered bits in an even-numbered page is proposed.

As illustrated in FIG. 20, a data format according to another aspect of the present invention adopts a method of writing 0 while crossing one bit in order to facilitate the bit error correction.

The method may include, for example, a method of writing 0 from the MSB in the odd-numbered page and 0 from a next bit of the MSB in the even-numbered page. In more detail, the pages are divided into two types of pages, and in one page, the counter value is written in the order of 010101 and in the other page, the counter value may be written in the order of 101010.

Accordingly, in the case of the data format illustrated in FIG. 20, the number of writable counts may be decreased to ½, but the error may be detected and corrected by referring to the data of the other page, and thus, there is an advantage in that the aforementioned program error may be easily detected and corrected.

Generally, adjacent pages are positioned to be physically adjacent to each other in a non-volatile memory. Accordingly, like FIG. 20, when the counter bits are disposed, memory cells in the page in which 0 and 1 are written may be physically disposed to cross in a diagonal direction. In other words, the memory cell in which 0 is written may be encapsulated in four directions with the memory cell writing 1 in the non-volatile memory. The memory cell in which 1 is written may also be encapsulated in four directions with the memory cell in which 0 is written. When the memory cell writing 1 is physically adjacent to the memory cell writing 1, the memory controller 301 may determine that the error is present in the counter. Since the error generation of the memory cell is cross-validated by other memory cells which are physically adjacent to each other, the arrangement of counter bits illustrated in FIG. 20 may have an error-resistant structure.

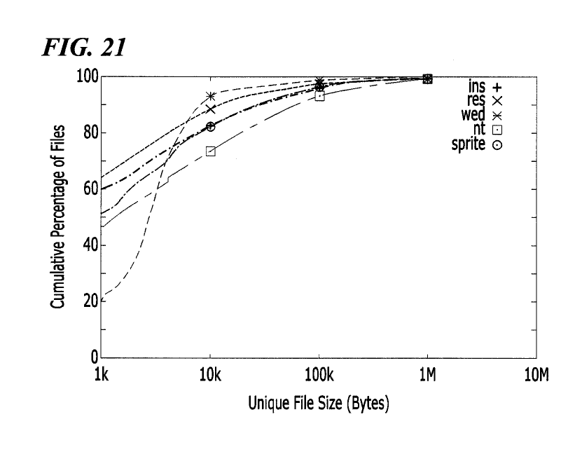

Next, FIG. 21 exemplifies a statistic distribution of a file-size wise.

Recently, high-capacity SSDs mainly use a page size of 4 KB. Furthermore, for example, in a future environment in which the SSD of 1 TB or more may be frequently used, a page with a size of 16 KB and 32 KB may also be considered.

In such a situation, the statistic distribution of the file-size wise is illustrated in FIG. 21. As illustrated in FIG. 21, it is revealed that files of 1 KB or less approximately occupy 50% of a total use capacity of the data files. That is, most of files which are frequently updated and used in a general computing system may be files of 1 KB or less.

The file size of 1 KB or less may be a very small size as compared with a general page size. Since only one file may be stored in one page, when one file is stored in one page, the files with the small size have no choice but to inefficiently be stored in the page.

With respect to the SSD, various address mapping algorithms for solving the problem that in-place overwrite is impossible may be present. For example, there may be a scheme in which storage blocks are divided into data blocks and log blocks and updated data are stored in the log blocks. In this case, in order to read the updated file, files positioned in the log block need to be searched as a page-level wise. In this case, when the page size is increased, latency caused due to the search may be caused. Further, as the capacity of the SSD is increased, a process for combining the log blocks may also cause excessive latency.

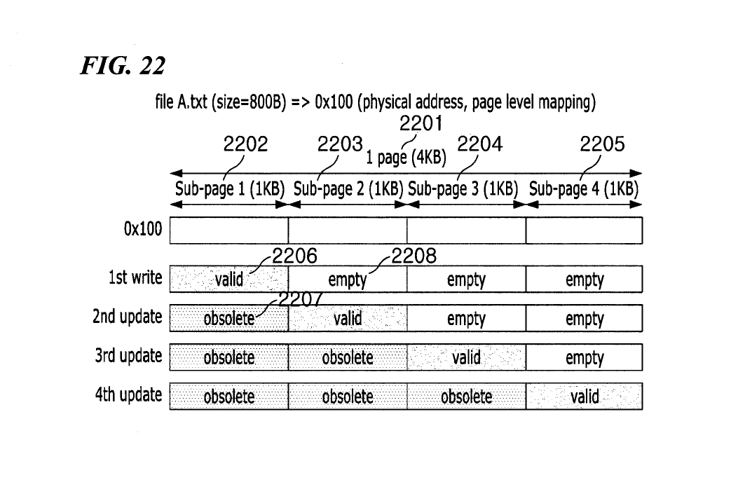

FIG. 22 illustrates an in-page overwriting scheme according to an aspect of the present invention.

As illustrated in FIG. 22, one page 2201 may be divided into a plurality of subpages 2202 to 2205 with a predetermined size. Here, the page may indicate an aggregate of memory cells corresponding to the same logic address in the memory. Referring to FIG. 22, as an example, fileA.txt with a size of 800 B is written to a page of which a physical address is 0x100.

For example, the page 2201 of 4 KB may be divided into four subpages 2202 to 2205 with a size of 1 KB. Input files with a small size (for example, files with a size of the subpage of 1 KB or less) may be allocated to the plurality of subpages 2202 to 2205 in the page 2201, written, and updated. Through the allocation, the number of non-used cells in the page may be minimized and the number of meta data updates may also be reduced. Accordingly, I/O performance of the memory may be improved and the lifespan of the memory may also be increased.

As described above, a flash memory such as the SSD has a property in which the in-place overwrite is impossible, and thus, generally, in one page, only one data may be written or updated. However, when one page is divided into the plurality of subpages, the problem may be solved. Represent while, in the present invention, the data update may represent a re-write or over-write request after an initial writing request for the corresponding data.

More particularly, as illustrated in FIG. 22, in response to the first writing request of the data, the memory controller 301 may write data in the first subpage 2202 of the page 2201. The memory controller 301 may set a write mode count based on the number of data write request times. The data may be sequentially allocated to the plurality of subpages 2202 to 2205 in the page 2201 by the count value.

When a reading module 305 reads the allocated data value, subpages to be read among the plurality of subpages 2202 to 2205 in one page 2201 may be determined based on the predetermined write mode count value. The determination may be performed by the memory controller 301.

When the data are written in the specific subpage, a state representing that the data are written may be marked or stored. In more detail, the subpages may have a plurality of states including a valid state 2206 that is a state in which the final update value of the data is written, an obsolete state 2207 in which a value before an update request of the data is written, and an empty state 2208 in which the data is not yet written. In this case, when the reading module 305 reads the allocated data value, based on the write order of the data for the plurality of subpages, a subpage just before the subpage having an initial empty state is determined as a valid subpage to read the data value written in the determined subpage.

Since overhead consumed to allocate and store side information such as a count value or a marking value is just approximately 1 to 4 bits per subpage or page, as compared with an effect of the present invention described above, the overhead is negligible cost.

Referring back to FIG. 22, after fileA.txt file is written in the first subpage 2202, when the update request for the corresponding file is input, the memory controller 301 may determine to overwrite the corresponding data file in the second subpage 2203. When the overwrite operation is performed, the state of the second subpage 2203 may be changed from empty to valid and the state of the first subpage 2202 may be changed from valid to obsolete.

Next, when an additional update request (that is, 3rd update and 4th update) for the corresponding file (that is, the file having the same logic address) is input, the data may be overwritten in the third subpage 2204 and the fourth subpage 2205 by the aforementioned operation.

As described above, a method of allocating each of a plurality of updates for the same file to a plurality of subpages of one page is proposed. Accordingly, since the same file is stored as subpages in one page and previously stored subpages are set in the obsolete state, in the data stored in the current subpage, a concern in which the file is broken may be reduced due to an effect of the data stored in a subsequent subpage.

In order to implement the aforementioned subpage update operations, the capacity of the corresponding data file requested to be updated needs to be smaller than the capacity of the subpage to be overwritten. Accordingly, the memory controller 301 determines the size of data requested to be written and may determine whether the determined size of the data is smaller than the size of the subpage. Next, the memory controller 301 may determine whether to allocate the data in the divided subpage based on the determination.

In FIG. 22, four divided subpages in one page are exemplified, but the pages and subpages with various sizes may also be included in the scope of the present invention. That is, it is apparent to those skilled in the art that four or more or less subpages may be included in the scope of the present invention.

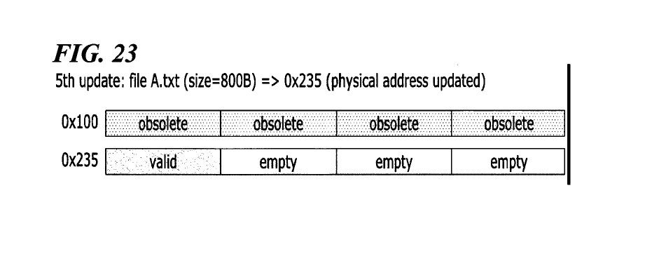

FIG. 23 illustrates an additional description of the in-page overwriting scheme according to an aspect of the present invention.

Referring to FIG. 23, when all of the subpages 2202 to 2205 of the corresponding page 2201 are used, all states of the subpages may be obsolete states. In the situation, when a fifth additional update request is input, a new page (0x235) may be allocated in the data file included in the additional update request.

Next, when a subsequent additional update request is input, sequential data allocation from the newly allocated page (0x235) to the subpages may be implemented as illustrated in FIG. 23.

In the related art, whenever the update request is input, the new page is allocated, but according to the allocation method according to the aspect of the present invention, the number of wasted cells in the pages may be reduced by the number of divided subpages.

Since an addressing operation or a reading operation is also implemented by a page wise, addressing for the subpages may be performed by reading the contents in the page. Furthermore, a flag for displaying whether the subpage is written may be marked (for example, 1 is empty and 0 is valid or obsolete). Accordingly, for example, when a 4-bit flag represents 0011, the reading module 305 or the memory controller 301 may easily determine that the second subpage is in the valid state.

Therefore, the present invention may efficiently use the space in the page at least two times as compared with the related art by pre-defining the subpages according to the block of the memory and allocating the data file to a proper block according to an input data file size.

Since the data written in the subpage in the obsolete state may be easily determined as the file with a version before update, an “undo function” may be achieved without using the additional cost. Furthermore, the present invention may be used as a shadow page which may be used for holding residual pages for each page.

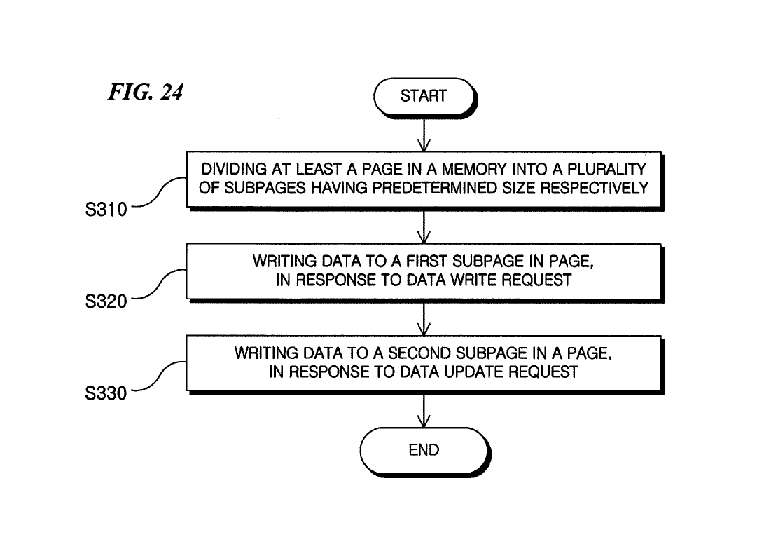

FIG. 24 is a flowchart for an in-page data writing method according to an aspect of the present invention.

The method illustrated in FIG. 24 may be performed by, for example, the memory controller 301. It will be apparent to those skilled in the art that additional steps other than steps illustrated in FIG. 24 may also be included in the method and some steps may be omitted.

Referring to FIG. 24, the memory controller divides at least one page in the memory into a plurality of subpages (S310). Here, the page is an aggregate of memory cells corresponding to the same logic address in the memory and each of the subpages may have a predetermined size. The predetermined size may be determined based on a size of one page, the number of subpages to be divided, and/or a size of a data file to be input.

In an aspect of the present invention, the plurality of divided subpages may have the same size or different sizes, respectively. Further, the number of divided subpages may also have various values.

Next, the memory controller writes the data in the first subpage in the page in response to the write request of the data (S320). The first subpage may be a predetermined subpage so that the writing of the data is first performed among the plurality of subpages in the page.

Next, the memory controller writes the data in the second subpage in the page in response to the update request of the data (S330). In this case, the update request may be a re-write request after the initial write request for the corresponding data.

Meanwhile, the memory controller may set a write mode count value which may be determined according to the number of times of the data write request. In an aspect of the present invention, the write mode count value may display a write mode in the page. The subpage to be read in the reading step may be determined based on the write mode count value.

In an additional aspect of the present invention, a flag for the subpage instead of the write mode count value may be stored. The write mode count value and/or the flag may be stored as a meta data in a meta area of the flash memory. Additionally, the write mode count value and/or the flag may be stored in a block or a page of a user area of the flash memory. Alternatively, the write mode count value and/or the flag may also be separately stored in each of the subpages in the page or stored in a header (not illustrated) in the page.

According to an aspect of the present invention, the memory controller may determine a size of the data to be written. According to the size of the data to be written, whether the data are written in a subsequent subpage may be determined. Next, the memory controller may compare the determined size of the data and the size of the subpage to be allocated. Base on the comparison, the memory controller may sequentially allocate the data to the subpages. For example, when the number of subpages is 3, the data may be sequentially allocated to the first subpage, the second subpage, and the third subpage.

In an additional aspect of the present invention, the memory controller may change and place the order of the subpages in order to implement the wear leveling. For example, a first subpage may have more data write count than the last subpage in the same page. The memory controller may change the layout of subpages in the page to which data will be allocated at a predetermined period or based on predetermined factors (for example, abrasion degrees of the respective subpages, write count for each subpage, an attribute of data, and the like). The change of the placement may include the shifting operation, the reversing operation, and the scrambling operation.

In more detail, the shifting operation represents shifting positions of the subpages. For example, the first subpage may be shifted to the position of the second subpage, and the second subpage may be shifted to the position of the third subpage. The shifting may be achieved in the reverse order, the second subpage may be shifted to the position of the first subpage, and the third subpage may be shifted to the position of the second subpage. Moreover, the shifting operation may include shifting to two or more subpage wises such as shifting the first subpage to the position of the third subpage, shifting the second subpage to the position of the fourth subpage, and the like.

The reversing operation may represent placing the subpages in the reverser order. Further, the scrambling operation may represent randomly (alternatively, according to a predetermined rule) mixing the order of the subpage.

Additionally, as an additional technique for implementing the wear leveling, the inversing operation is presented. The inversing operation represents inverting and writing values of 0 and 1 of input data.

The memory controller may select one of various wear leveling techniques based on predetermined factors (for example, abrasion degrees of the respective subpages, write count for each subpage, an attribute of data, and the like).

Various aspects or features described herein can be implemented as methods, apparatuses, or manufactured articles using stand programming and/or engineering techniques. Steps and/or operations of a method or algorithm described in association with the aspects disclosed herein can be directly implemented as hardware, a software module executed by a processor, a combination thereof. Additionally, in some aspects, the steps or operations of the method or algorithm can be present as at least one or predetermined combination of sets of codes or commands on a machine-readable or computer-readable medium and can be integrated into a computer program article. The terms manufactured article used herein is intended to include a computer program accessible by a predetermined appropriate computer-readable device or medium.

The description of the presented exemplary embodiments is provided so that those skilled in the art of the present invention use or implement the present invention. It will be apparent to those skilled in the art that various modifications of the exemplary embodiments will be apparent to those skilled in the art and general principles defined herein can be applied to other exemplary embodiments without departing from the scope of the present invention. Therefore, the present invention is not limited to the exemplary embodiments presented herein, but should be analyzed within the widest range which is consistent with the principles and new features presented herein.

### MODE FOR INVENTION

As previously described, mode for invention is fully described in best mode

### INDUSTRIAL APPLICABILITY

Present invention may be applied to various memories and memory systems which includes the memories.

1. A method for controlling a memory system including a memory and a memory controller configured to control the memory, the method comprising:
dividing, respectively, at least one page in the memory into a plurality of subpages, the page being an aggregate of memory cells corresponding to the same logical address in the memory and the respective subpages having a predetermined size;
writing, in response to a writing request of data, the data in a first subpage in the page; and
writing the data in a second subpage of the page in response to an update request for the data, the update request being a rewriting request after an initial writing request for the corresponding data.

2. The method of claim 1, wherein the writing of the data in the first subpage includes:
determining the size of data of which writing is requested;
determining whether the determined size of the data is smaller than the size of the subpage; and
writing the data in the divided first subpage when the determined data size is smaller than the size of the subpage.

3. The method of claim 1, further comprising:
setting a write mode count based on the number of writing request times for the data; and
sequentially writing the data in the divided subpages according to the set write mode count.

4. The method of claim 3, further comprising:
reading a value of the written data,
wherein a subpage to be read among the plurality of subpages is determined based on the value of the set write mode count.

5. The method of claim 1, wherein the subpages at least include a plurality of states including a valid state in which a final update value of the data is written, an obsolete state in which a value before the update request of the data is written, and an empty state in which the data is yet not written, and
a state of the first subpage is changed from the valid state to the obsolete state to correspond to the writing the data in the second subpage.

6. The method of claim 5, further comprising:
reading the value of the written data,
wherein a value of data written in a last subpage which is positioned previous to a subpage having an initial empty state in a writing order of the data in the plurality of subpages is read.

7. A memory system comprising:
a memory having a plurality of physical blocks, each of the plurality of physical blocks including a plurality of pages; and
a memory controller configured to control the memory,
wherein the memory controller includes:
a control module dividing, respectively, at least one page in the memory into a plurality of subpages, the page being an aggregate of memory cells corresponding to the same logical address in the memory and the respective subpages having a predetermined size; and
a programming module writing data in a first subpage in the page in response to a writing request of the data and writing the data in a second subpage of the page in response to an update request for the data, the update request being a rewriting request after an initial writing request for the corresponding data.
